(19) United States
(12) Patent Application Publication
(10) Pub. No.: US 2025/0315667 A1
(43) Pub. Date: Oct. 9, 2025

(54) STACKED NEURAL NETWORK MODELS-ON-SILICON FORMING AN AI CUBE

(71) Applicant: Intel Corporation, Santa Clara, CA (US)

(72) Inventors: Yaron Klein, Rosh Haayin (IL); Yoni Elron, Hadera (IL); Tatyana Druz, Hadera (IL); Stanislav Borisover, Haifa (IL); Yuval Vered, Tel-Aviv (IL); Sakthi Prashanth, Portland, OR (US); Mudit Bhargava, Austin, TX (US)

(73) Assignee: Intel Corporation, Santa Clara, CA (US)

(21) Appl. No.: 19/244,620

(22) Filed: Jun. 20, 2025

Related U.S. Application Data
(60) Provisional application No. 63/672,537, filed on Jul. 17, 2024.

(51) Int. Cl. G06N 3/063; G06N 3/045

(52) U.S. Cl. CPC G06N 3/063; G06N 3/045

(57) ABSTRACT

Building on the models-on-silicon (model-on-chip or model-on-die) architecture and design, multiple models-on-silicon chips/dies can be arranged in a stacked formation to form a single cube, referred to herein as AI cube. Each of these chips or dies can embed one or more transformer blocks, such as one or more consecutive transformer blocks of a transformer-based neural network. This stacked configuration enables processing of data in a feedforward manner, effectively performing processing for an inference task of a transformer-based neural network, e.g., an entire large language model, within one compact semiconductor integrated circuit package. For example, a 70 billion parameter LLM can be arranged and implemented onto an AI cube, where different groups of transformer blocks are distributed to different chips in the AI cube in a feedforward manner.

### CROSS-REFERENCE TO RELATED APPLICATION(S)

This application claims priority to and/or receives benefit from U.S. Provisional Application No. 63/672,537, filed on 17 Jul. 2024 and titled “STACKED NEURAL NETWORK MODELS-ON-SILICON FORMING AN AI CUBE”. The US Provisional Application is hereby incorporated by reference in its entirety.

### BACKGROUND

Deep neural networks (DNNs) are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as there can be a large number of operations as well as a large amount of data to read and write.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an exemplary chip architecture, according to some embodiments of the disclosure.

FIG. 2 illustrates exemplary details within the parts of the exemplary chip architecture, according to some embodiments of the disclosure.

FIG. 3 illustrates embedding an exemplary open-source model onto the chip, according to some embodiments of the disclosure.

FIG. 4 illustrates exemplary hardware blocks representing an exemplary open-source model, according to some embodiments of the disclosure.

FIG. 5 illustrates a sequential read-only memory, according to some embodiments of the disclosure.

FIG. 6 illustrates a sequential read/write memory in an attention multiplier circuit, according to some embodiments of the disclosure.

FIG. 7A illustrates an exponent unit circuit, according to some embodiments of the disclosure.

FIG. 7B illustrates an exponent function, according to some embodiments of the disclosure.

FIG. 8A illustrates a sigmoid linear unit (SILU) activator circuit, according to some embodiments of the disclosure.

FIG. 8B illustrates a sigmoid linear unit function and a rectified linear unit (RELU) function, according to some embodiments of the disclosure.

FIG. 9 illustrates a weights multiplier circuit, according to some embodiments of the disclosure.

FIG. 10 illustrates an embedding dot unit circuit, according to some embodiments of the disclosure.

FIG. 11 illustrates bit cell area optimization, according to some embodiments of the disclosure.

FIG. 12 illustrates a weights multiplier circuit, according to some embodiments of the disclosure.

FIG. 13 illustrates a SoftMax circuit, according to some embodiments of the disclosure.

FIG. 14 illustrates an embedder circuit, according to some embodiments of the disclosure.

FIG. 15 illustrates a root mean square (RMS) normalizer circuit, according to some embodiments of the disclosure.

FIG. 16 illustrates a sampler circuit, according to some embodiments of the disclosure.

FIG. 17 illustrates a sampling comparator circuit, according to some embodiments of the disclosure.

FIG. 18A illustrates a rotary positional encoding circuit, according to some embodiments of the disclosure.

FIG. 18B illustrates a cosine function and a sine function, according to some embodiments of the disclosure.

FIG. 19A illustrates using multiple chips to implement a large transformer model, according to some embodiments of the disclosure.

FIG. 19B illustrates using multiple chips to implement a large transformer model, according to some embodiments of the disclosure.

FIG. 20 illustrates hardware-based inferencing process with embedded large language model (LLM) and read-only memory (ROM), according to some embodiments of the disclosure.

FIG. 21 illustrates a matrix multiplication operation, according to some embodiments of the disclosure.

FIG. 22 illustrates an embedded weights fused multiply-add architecture, according to some embodiments of the disclosure.

FIG. 23 illustrates an exemplary stacked architecture and design, according to some embodiments of the disclosure.

FIG. 24 illustrates hardware-based inferencing process with an artificial intelligence (AI) cube, according to some embodiments of the disclosure.

FIG. 25 illustrates airflow configuration of the stacked architecture and design, according to some embodiments of the disclosure.

FIG. 26 illustrates microchannels in the stacked architecture and design, according to some embodiments of the disclosure.

FIGS. 27-28 illustrate an exemplary implementation of an LLM onto the stacked architecture and design and exemplary data flow of the implementation, according to some embodiments of the disclosure.

FIG. 29 illustrates hardware-based inferencing process with an AI cube, according to some embodiments of the disclosure.

FIG. 30 is a flow diagram illustrating a method for performing inference on a AI cube, according to some embodiments of the disclosure.

FIG. 31 is a block diagram of an exemplary computing device, according to some embodiments of the disclosure.

### DETAILED DESCRIPTION

### Technical Problem

The problem being solved is the need for a cost-effective, dedicated solution for AI inference tasks. Huge AI models are capable of addressing any small-scale need (for example, audio to text, robotics, or the like). These huge models are expensive in power and performance and are therefore limited in terms of implementation. For example, a humanoid system may use a huge battery to perform simple tasks, and real-time response time can be difficult or close to impossible to achieve. Such systems may also require Internet connectivity to a cloud computing environment that implements the huge model and thus cannot autonomously execute in an isolated environment. Huge AI models have been implemented in software, but a software solution can be inefficient in terms of performance and energy (e.g., per token). Software solutions can be sufficient for conducting time-insensitive calculations, but not for applications that may demand real-time performance.

An example of a model that can carry out an inferencing task is a transformer-based neural network. An example of a transformer-based neural network that is used often is the LLM, which can be used to understand, generate, and manipulate human language. Some transformer-based neural network can operate on one or more modalities (e.g., audio, text, images, video, signals, etc.). Transformer-based neural networks are a type of deep learning model that can handle sequential data. Transformer-based neural networks can employ self-attention to weight the importance of different words in a sentence, or different tokens in a sequence of tokens, to capture context and relationships. Transformer-based neural networks can have millions to billions of trainable weights to capture the context and relationships. It is not trivial to implement these transformer-based neural networks on hardware, due to the extreme amounts of processing and the amount of weights involved in the processing.

While general-purpose solutions like Graphics Processing Units (GPUs), Tensor Processing Units (TPUs), and Central Processing Units (CPUs) can be utilized for both training and inference, they are not cost-effective for inference on a given model alone due to their inherent design to handle a wide range of tasks, including the repetitive loading of the LLM including its weights.

In a GPU-based solution, model weights are loaded from memory every time a machine learning inference task is performed. This process consumes significant power and time, particularly for complex models. GPUs are designed in a generic manner to handle a wide range of tasks, making them inefficient for dedicated tasks like inference on a pre-trained model alone.

In a field programmable gate array (FPGA) based solution, programmable hardware can be customized to perform specific tasks, including loading and handling LLM weights, to make machine learning inference more efficient. While FPGAs offer flexibility, they can require significant programming effort and expertise to be utilized effectively. They also have lower performance compared to dedicated hardware solutions and are not as power-efficient and not cost-effective.

In CPU-based solutions, CPUs can be programmed to perform machine learning inference tasks. CPUs are not suitable for large-scale matrix multiplications which can be essential for machine learning inference tasks. They also consume more power and are slower in comparison to dedicated solutions.

In the inferencing process with GPU acceleration, the user initiates the sequence by providing input data for analysis. This data undergoes tokenization and embedding generation, transforming it into a format suitable for machine learning models. The system then loads the pre-trained model into memory, along with its associated weights, which are the learned parameters crucial for making predictions. Once the GPU is initialized, the model weights and embeddings are transferred to the High Bandwidth Memory (HBM), a specialized memory architecture designed for high-speed data transfer. The data is then shuttled from the HBM to the GPU cores, where the actual inferencing computations take place in parallel. After processing, the data is moved back to the HBM. A significant challenge in this workflow is the data transfer between the HBM and the GPU cores. While HBM offers high bandwidth, the repeated movement of data can create a bottleneck, leading to latency issues that can diminish the overall performance gains from GPU acceleration. Each transfer incurs a cost in time and energy, and when dealing with large datasets or complex models, these costs can accumulate, impacting the efficiency of the inferencing process. Optimizing data movement, reducing the frequency of transfers, and ensuring that the GPU cores have sufficient work to perform while data is in transit are critical considerations in maximizing the performance of GPU-accelerated machine learning inference.

### Overview of Models-On-Silicon

Various other solutions, while capable of performing machine learning inference tasks, are lacking in one aspect or another. To overcome at least some of these limitations, a dedicated, efficient, and cost-effective chip can be designed and implemented for machine learning inference. In particular, the chip can be designed to support and perform inference according to a transformer-based neural network, such as an open-source transformer-based neural network or an open-source LLM.

According to one aspect, the disclosed solution, referred to herein as models-on-silicon, introduces a groundbreaking chip architecture that is specifically designed to encapsulate the LLM weights and inference architecture directly onto the hardware. This unique models-on-silicon architecture design optimizes a given LLM by etching the weights onto the chip, eliminating the recurring task of loading these weights and model into GPUS every time.

According to one aspect, the models-on-silicon architecture utilizes a sequential read-only memory to store one or more weights of a transformer-based neural network. The weights of the transformer-based neural network are thus etched onto the sequential read-only memory and fixed onto the hardware. An application processor no longer has to load weights onto memory or compile a processing graph of a transformer-based neural network and load the compiled instructions onto the GPU. In some embodiments, the sequential read-only memory may power up an active word line and a next active word line and powers down one or more other word lines.

According to one aspect, the models-on-silicon architecture includes a memory to store a key-value cache for the transformer-based neural network. The memory to store the key-value cache may be a sequential read memory. The key-value cache may be a sequential write memory.

The one or more memories in the models-on-silicon architecture can be sequential and do not require random-access. Each line can be read in its designated time slot along with the operation for it. This maximizes performance, simplifies routing, and enables quick access to data, weights, key-value cache, and/or activations.

According to one aspect, the models-on-silicon architecture facilitates placing one or more memories in close proximity to the custom-built circuits that are performing the logic operations. The architecture not only frees up the need to persistently retrieve an LLM's weights from a main memory (e.g., a large static random-access memory (SRAM)) for each computation but also allows the data to be strategically positioned in close proximity to the logic operations.

According to one aspect, the models-on-silicon architecture has one or more (custom-built) circuits to perform the logic operations and/or calculations of the transformer-based neural network. The custom-built or purpose-built circuits encapsulate operations of the inference architecture directly on hardware. Custom circuits can be highly efficient and have low-power consumption and smaller area.

According to one aspect, the one or more circuits include a read-only memory to store a look up table (LUT) having one or more precomputed values of an exponent function.

According to one aspect, the one or more circuits include a read-only memory to store a look up table having one or more precomputed values of a sigmoid linear unit function.

According to one aspect, the one or more circuits include a (custom-built) multiplier circuit to multiply an embedding value of an embedding vector of the transformer-based neural network and a weight value of a weight matrix of the transformer-based neural network. In some cases, the weight value can be read from a sequential read-only memory.

In some cases, the multiplier circuit is specifically designed to perform multiplication of an 8-bit floating-point (FP8) number and a 6-bit floating-point (FP6) number. For example, the weight value may be a 6-bit floating-point number, and the embedding value is an 8-bit floating-point number. In some cases, the multiplier circuit is specifically designed to perform multiplication of an FP8 number and a 4-bit floating-point (FP4) number. For example, the weight value may be a 4-bit floating-point number, and the embedding value is a 8-bit floating-point number. In some cases, the multiplier circuit is specifically designed to perform multiplication of an FP6 number and an FP4 number. For example, the weight value may be a 4-bit floating-point number, and the embedding value is a 6-bit floating-point number. In some cases, the multiplier circuit is specifically designed to perform multiplication of a 16-bit floating-point (FP16) number and a FP16 number.

According to one aspect, the multiplier circuit includes a multiplexer to allow the bypassing of the etched weight value and use a different weight value instead. In some cases, an application processor may selectively apply one or more weight values of a low-rank weight matrix that was generated by fine-tuning the transformer-based neural network. In such cases, the weight value to be used or processed in the multiplier circuit can be read from a read-write memory storing the one or more weight values of the low-rank weight matrix. In some cases, one or more etched weight values may have errors, and one or more repair weight values can be selectively applied in place of the etched weight values. In such cases, the weight value to be used or processed in the multiplier circuit can be read from a read-write memory storing one or more repair weight values for the transformer-based neural network.

According to one aspect, the one or more circuits include a tree adder circuit. According to one aspect, the one or more circuits include a tree comparator circuit. The tree/hierarchical structures facilitate processing a large number of inputs in parallel to produce a final output. The tree/hierarchical structures can perform processing in a feedforward manner without recursion. In some cases, the adders in the tree adder operate with wide bit-width numbers to avoid overflow.

According to one aspect, the models-on-silicon architecture includes a flow control circuit (also referred to as a sequencer, a sequencer circuit, an orchestrator circuit, etc.). The flow control circuit orchestrates the operations of a transformer-based neural network in a feedforward manner, as if following a predetermined timing sequence or recipe of operations. Because the models-on-silicon chip implements a predetermined inferencing task of a predetermined transformer-based neural network, the timing sequence of operations (including how many clock cycles each operation takes, the data flow between operations, etc.) is known or established ahead of time. The timing sequence can specify one or more operations of an inferencing task of the transformer-based neural network to be performed at a given clock cycle. The timing sequence may specify the overall sequence of operations to be performed. The timing sequence can specify the data being processed by a given operation. The timing sequence can specify the data being generated by a given operation. The flow control circuit may control gates, muxes, flip-flops, etc., to execute the timing sequence and orchestrate the (custom-built) circuits to perform the operations according to the timing sequence. The flow control circuit can control the data flow into and/or out of the one or more (custom-built) circuits. The flow control circuit can enable and/or disable the one or more (custom-built) circuits according to a predetermined timing sequence. The flow control circuit may include digital logic to generate control signals, timing signals, trigger signals, etc., which can be used to control one or more of: gates, muxes, flip-flops, and custom circuits. The signals can cause the one or more (custom-built) circuits to follow and execute operations of the transformer-based neural network, e.g., in a feedforward manner, according to the predetermined timing sequence.

According to one aspect, the models-on-silicon chip architecture embeds a feedforward-only transformer-based neural network. In comparison to other solutions, the models-on-silicon chip architecture avoid the need to implement software, complex program control or counters, or back propagation, since the model is only feedforward. The models-on-silicon chip architecture and the hardware execution timing sequence involve only forward pass.

The models-on-silicon chip encapsulates a LLM inferencing model on a single chip and includes a token interface that can demand low bandwidth per inferencing task into the system-on-a-chip (SoC). The models-on-silicon architecture ensures a highly scalable solution, as any number of SoCs can be connected in parallel to handle multiple batches of inference requests simultaneously with low overhead. The models-on-silicon design revolutionizes the way AI inference tasks are handled, making it both cost-effective and scalable.

One of the advantages of the disclosed solution is its cost-effectiveness. Unlike general-purpose GPUs, this chip is specifically designed to handle AI inference tasks, and thus, does not carry any overhead of unnecessary or general-purpose functionalities. This focus on specific tasks makes it a much more cost-effective solution. The disclosed solution enables faster machine learning inference and reduces power consumption, can offer offering a more efficient and environmentally friendly solution for artificial intelligence tasks.

This disclosed models-on-silicon solution solves the problem of cost, high power consumption, and time delay, in AI inference by integrating the LLM weights and model onto the hardware itself, effectively removing the need to load weights onto the GPU every load. In some embodiments, the chip includes custom-built circuits for matrix multiplication, allowing for efficient computation. By embedding the weights and the model onto the hardware, power consumption is significantly reduced, and inference tasks are completed faster, while cost is low. The disclosed solution can be visualized as a chip with multiple modules for computations and dedicated sections for weight storage. Various aspects can together contribute to increased performance, scale, reduction of power consumption and area on the chip, reduction in real-time compute calculations, and more.

By hardcoding the LLM weights and architecture onto the chip, the time and power to load these weights from memory are significantly reduced. As a result, inference tasks can be executed faster, providing a significant performance boost. The disclosed solution reduces power consumption by eliminating the need to repeatedly load weights and models from memory for each inference task. This makes the solution more power-efficient, reducing the overall operational cost, and making it a more environmentally friendly solution. Unlike general-purpose GPUs or FPGAs, this dedicated chip is specifically designed to handle AI inference tasks. Therefore, it does not carry any overhead of unnecessary or general-purpose functionalities, making it a more cost-effective solution. Due to encapsulation of a full LLM inferencing model on a single chip and a token interface, requiring a very low bandwidth per inferencing task into the SoC, a number of SoCs can be connected to in parallel to simultaneously handle multiple batches of inference requests with low overhead, making the disclosed solution scalable. Because the model and weights are hardcoded into the hardware, model integrity is assured and less susceptible to manipulation. The disclosed solution can be more secure. The power efficiency and performance boost offered by this invention make it ideal for real-time computing, such as edge computing, mobile and Internet of Things (IoT) applications where resources are limited, and low latency may be required.

Relative to solutions where model weights are stored in HBM, the models-on-silicon chip is much faster, with 150× better latency, because the data is located where it is used. In addition, the models-on-silicon chip is more power-efficient due to the use of sequential read-only memories with 3000× better power efficiency. Relative to solutions that support generic matrix-to-matrix multiplication, vector-to-matrix multiplication, and matrix-to-vector multiplication, the models-on-silicon chip implements a predefined matrix multiplier to perform vector dot product operations that multiply an FP8 valued vector and FP6 valued vector to enable optimization in the hardware bit level, save die area, enable faster operations, and reduce power. Relative to solutions that compute values for activations, the models-on-silicon chip implements predefined look up tables with values precalculated in advance to save compute calculations in real-time. Relative to solutions where the model definition has to be compiled and loaded to run the model, the models-on-silicon chip while being less flexible, can enable highly optimized hardware design, save die area, enable faster operation, and reduce power.

Applications that can potentially benefit from having a more efficient solution may include huge AI models with hundreds of billions of parameters deployed on GPUs, TPUs, CPUs and cloud computing environments, mid-to-small AI models with a few to a dozen billion parameters deployed in humanoid robots and personal computers, and tiny AI models with less than a billion parameters deployed on mobile devices. Use cases that can benefit from having a more efficient solution may include real-time speech-to-text, real-time text-to-speech, dictation, translation, personal assistance, LLM operating system, LLM supervisor activating experts like coding LLM and productivity LLM, autonomous robots with reasoning, humanoids, cars, appliances, smart carts, smart factories, video-to-tokens, generating video tokens for LLMs training at scale, etc.

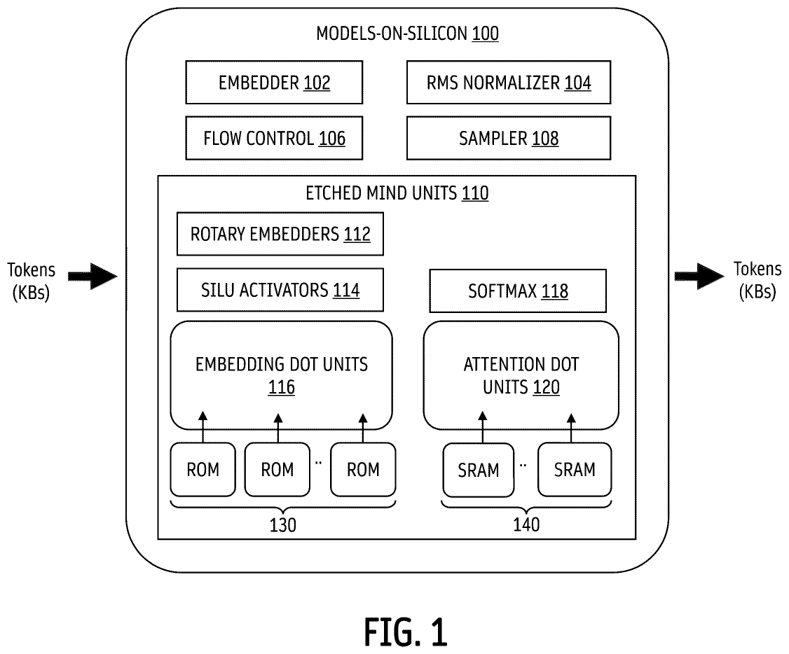

FIGS. 1-22 detail the innovations with models-on-silicon chip and architecture.

### AI Cube as a Further Solution and Technical Advantages Thereof

Building on the models-on-silicon (model-on-chip or model-on-die) architecture and design (where the model can be up to 10B parameters) as illustrated in FIGS. 1-22, multiple models-on-silicon chips/dies can be arranged in a stacked formation to form a single cube, referred to herein as AI cube. The term “cube” is not limited to a perfect geometric cube but may refer to a suitable vertically stacked or cubic structure. Each of these chips or dies can embed one or more transformer blocks, such as one or more consecutive transformer blocks of a transformer-based neural network. Herein, a transformer block is also referred to as a transformer. This stacked configuration enables processing of data in a feedforward manner, effectively performing processing for an inference task of a transformer-based neural network, e.g., an entire LLM, within one compact semiconductor integrated circuit package.

The chips or dies can be connected through a wire, a conductive path, a conductive trace, input connection, output connection, or a general-purpose input/output (GPIO) connection. Transformer blocks of a transformer-based neural network operate or work one by one, batching them into groups and distributing different groups of transformer blocks into separated chips/dies means that only one chip/die would be active at any given time. Because only one chip is active at any given time, the stacked configuration can operate with little to no thermal concerns.

In one technique, integrated circuits or dies can be stacked vertically, or along one direction, to achieve high-performance and low-power consumption. The AI cube architecture improves upon this structure by ensuring that only one chip/die is active at a time. Having just one chip/die being active at a time reduces overall power consumption and heat generation. Furthermore, the use of a simpler GPIO connection system also reduces the complexity of the manufacturing process.

In one technique, individual chips are placed onto a wafer to allow for high-density chip placement. The AI cube architecture improves upon this structure by ensuring that only one chip/die is active at a time in the LLM AI model. Having just one chip/die being active at a time reduces power consumption and heat generation. Furthermore, the use of a simpler GPIO connection system also simplifies the interconnect system.

In one technique, entire wafers are stacked on top of each other to allow for high-density stacking of wafers. The AI cube architecture improves upon this structure by ensuring that only one chip/die is active at a time in the LLM AI model. Having just one chip/die being active at a time reduces power consumption and heat generation. Furthermore, the AI cube manufacturing process is simpler and less prone to defects.

In one technique, dies are bonded together using a combination of direct bonding and intermediate layers, which enables high-density interconnects. The AI cube architecture improves upon this structure by ensuring that only one chip/die is active at a time in the LLM AI model. Having just one chip/die being active at a time simplifies power routing and reduces power consumption. The AI cube architecture can be more power-efficient.

The models-on-silicon solution as illustrated in FIS. 1-22 can improve upon GPU-based solutions, FPGA-based solutions, and CPU-based solutions. The AI cube architecture having a stack of models-on-silicon chips/dies can also have the same improvements by virtue of using the models-on-silicon architecture in the stack.

According to one aspect, an integrated circuit device has a plurality of chips forming an AI cube. A chip can have a stacking side, which can face another chip. A chip can have two stacking sides, where one or both of the stacking sides may be stacked against another chip in the AI cube. A stacking side can have a square or rectangular shape. A chip can also have non-stacking sides (e.g., edges or sidewalls), which do not face another chip. A chip can include four non-stacking sides when the stacking side has a square or rectangular shape. A non-stacking side can be adjacent to, flanks, or joins with a stacking side. A stacking side is significantly larger than a non-stacking side. A non-stacking side is where the chip is cut from a larger silicon wafer.

A chip in the plurality of chips in an AI cube can include one or more parts of the models-on-silicon chip architecture. A first chip can include a sequential read-only memory to store weights of a weight matrix of a transformer-based neural network and circuits to perform operations of an inferencing task of the transformer-based neural network. A second chip can be disposed at a stacking side of the first chip and be stacked with the first chip. A stacking side of the second chip can face the stacking side of the first chip. The second chip can include a further sequential read-only memory to store weights of a further weight matrix of the transformer-based neural network and further circuits to perform further operations of the inferencing task. One or more further chips can be provided in the stack as part of the AI cube. The first chip and the second chip can be communicably coupled together via a conductive path, such as a GPIO connection. The first chip can have an output pin, and the second chip can have an input pin. The conductive path can couple the output pin of the first chip to the input pin of the second chip. The conductive path can be added during the manufacturing process easily without requiring sophisticated processes.

A chip can include one or more layers, such as a logic layer having the circuits to perform the operations of the inferencing task, and a power layer having a power delivery network (e.g., having metal lines and vias) for distributing power and grounding for the circuits in the logic layer.

In some implementations of the AI cube, the second chip has a power layer at the stacking side of the second chip that faces the stacking side of the first chip having the logic layer. If a third chip is stacked on the second chip, the power layer of the third chip can face the logic layer of the second chip. In some implementations, the arrangement in the AI cube stacked in this manner offers a unique air flow configuration that creates a channel for air flow in a direction different from other cooling systems. An airgap or an airgap layer can be provided between the chips, e.g., between the power layer of the second chip and the logic layer of the first chip. The airflow through the airgap layer between stacked chips can aid in cooling and prevent heat accumulation between the stacked chips in the AI cube.

The conductive paths connecting the chips of the AI cube can run along one non-stacking side of the chips, and power rail connections to bond pads to supply power to the chips can run along another non-stacking side of the chips (e.g., the opposite non-stacking side). This feature can simplify routing and wiring design and the manufacturing process for assembling the stacked AI cube.

In some implementations of the AI cube, one or more of the stacking sides of chips facing each other can form microfluidic channels between the chips. The microfluidic channels can be etched or formed directly on the surfaces of the silicon wafers having the chips during the fabrication process. The microfluidic channels can be filled with a cooling liquid to assist with cooling and carry heat away from the AI cube.

In some implementations of the AI cube, one of the chips in the AI cube can have a dedicated input interface, such as a cable interface, or a peripheral component interconnect express (PCIe) interface, to receive one or more input tokens to the transformer-based neural network, e.g., from a host processor running an application. The same chip or a different chip in the AI cube can have a dedicated output interface, such as a cable interface, or a PCIe interface, to output an output token produced by the transformer-based neural network, e.g., to the host processor. This feature makes it simple for the host processor to instruct the AI cube to perform an inferencing task using the embedded transformer-based neural network. The host processor only needs to send input tokens to the AI cube and receive output tokens from the AI cube. No compiled instructions or configurations are needed to be sent to the AI cube.

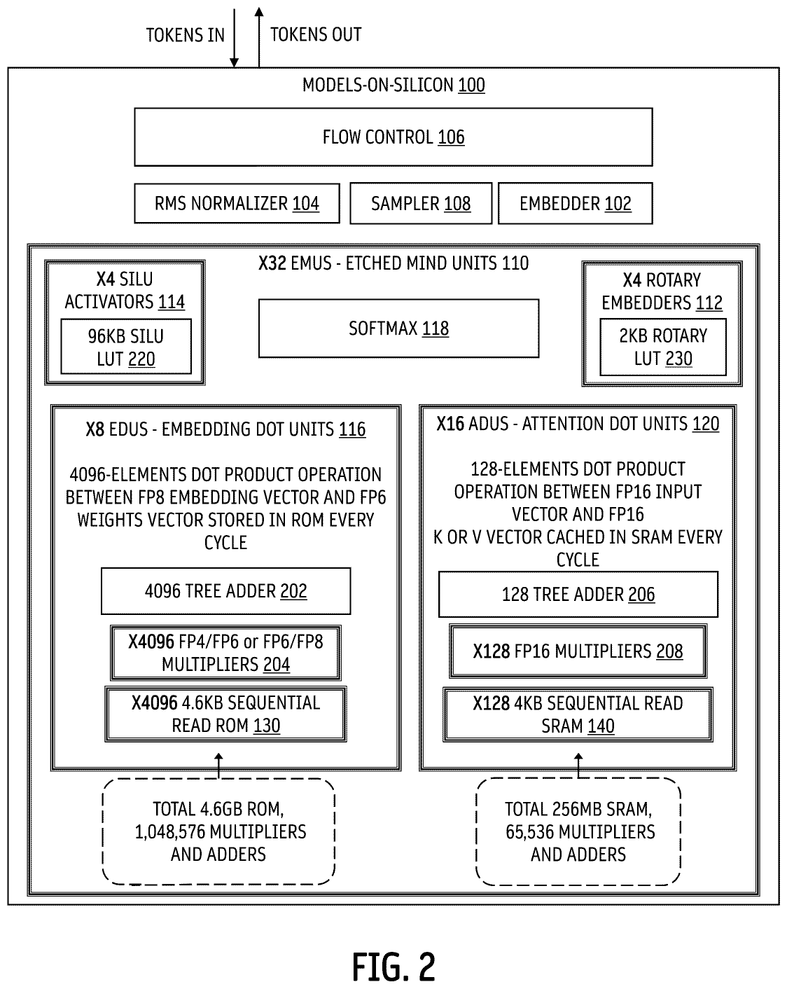

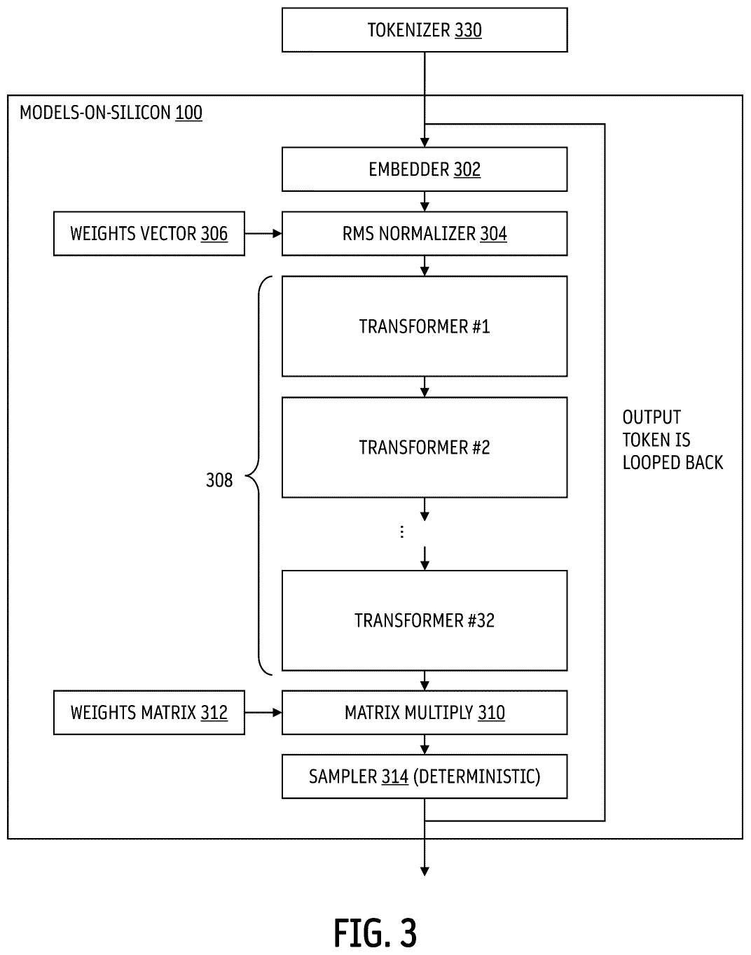

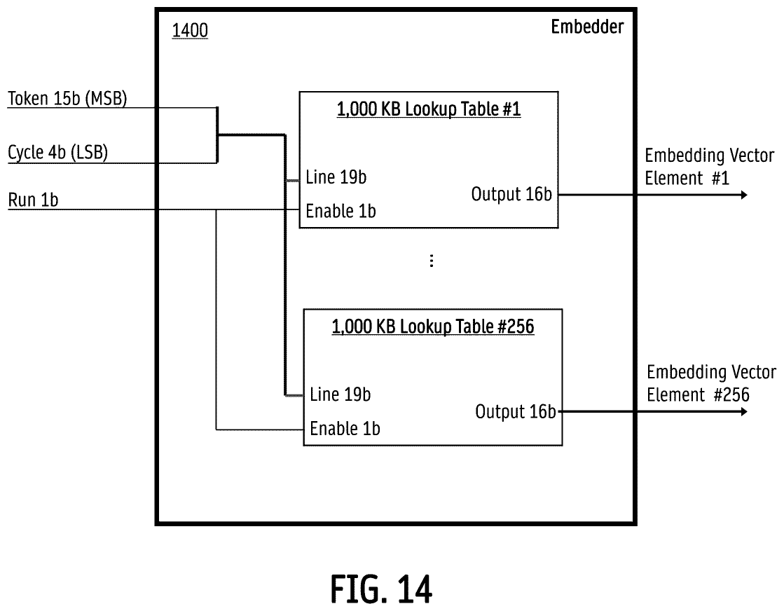

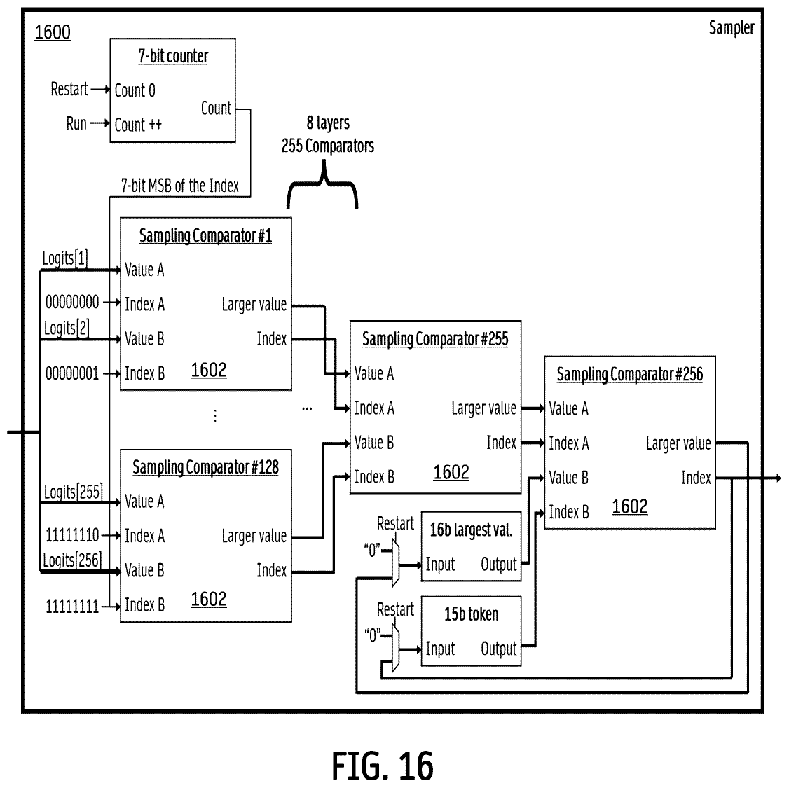

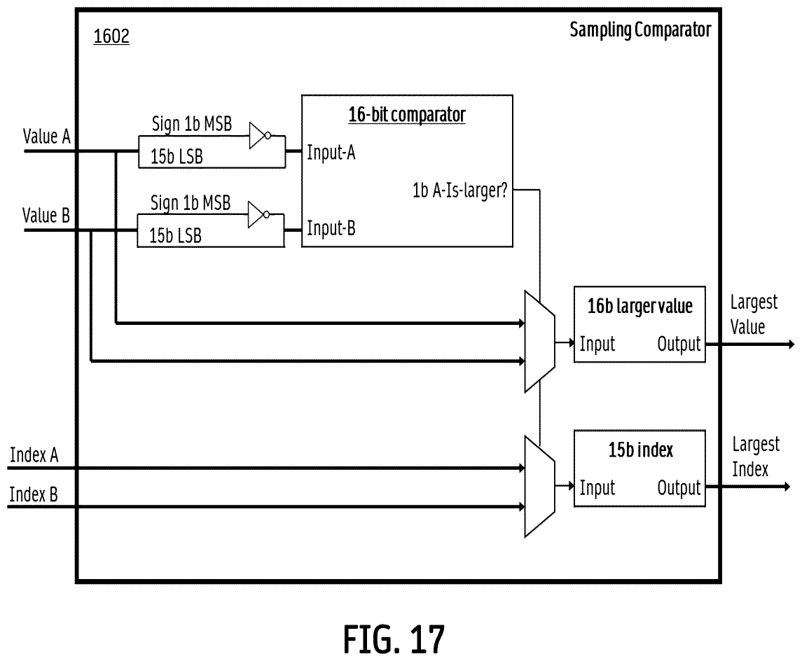

In some implementations of the AI cube, one of the chips in the AI cube can include a sampler circuit. The sampler circuit can implement operations associated with sampler 314 of FIG. 3, which is towards the end of the transformer-based neural network. The sampler circuit is illustrated as sampler circuit 108 of FIGS. 1-2. An exemplary implementation of the sampler circuit is illustrated in FIGS. 16-17. The same chip or a different chip can include an embedder circuit. The embedder circuit can implement operations associated with embedder 302 of FIG. 3, which is towards the beginning of the transformer-based neural network. The embedder circuit is illustrated as embedder circuit 102 of FIGS. 1-2. An exemplary implementation of the embedder circuit is illustrated in FIG. 14.

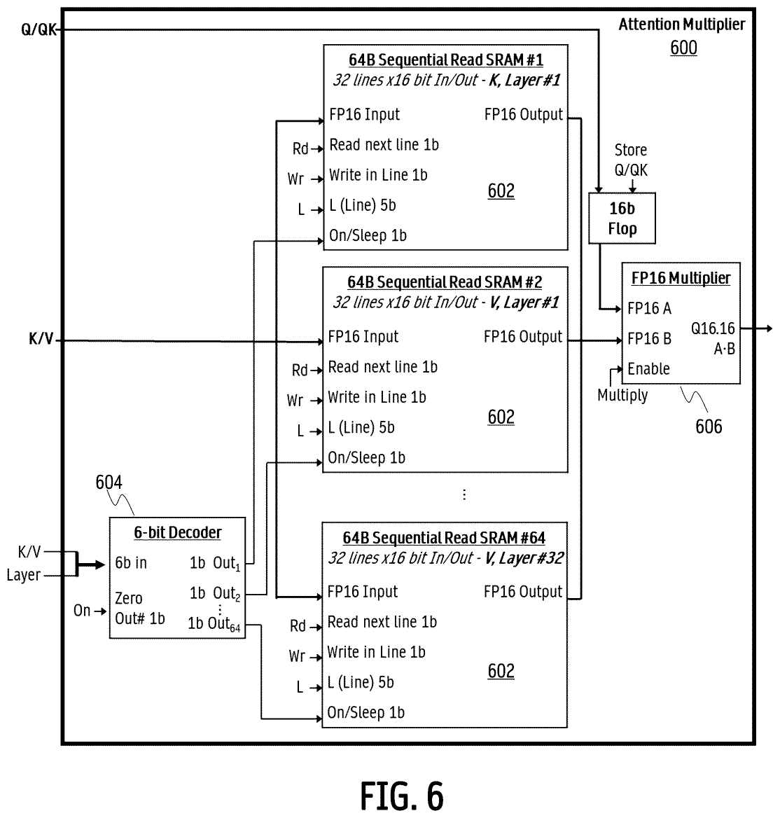

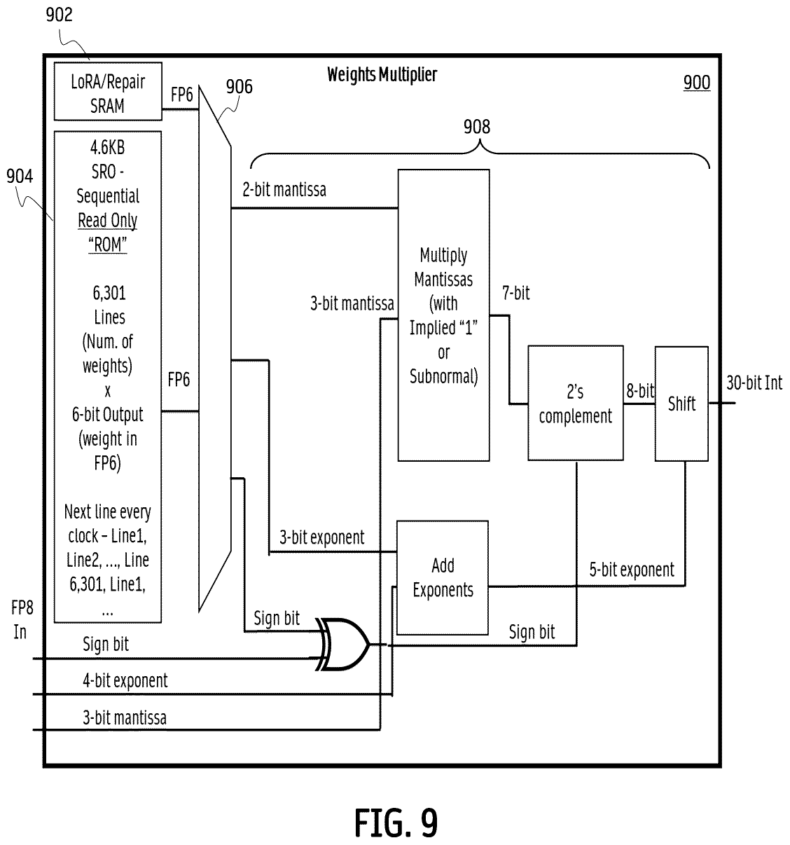

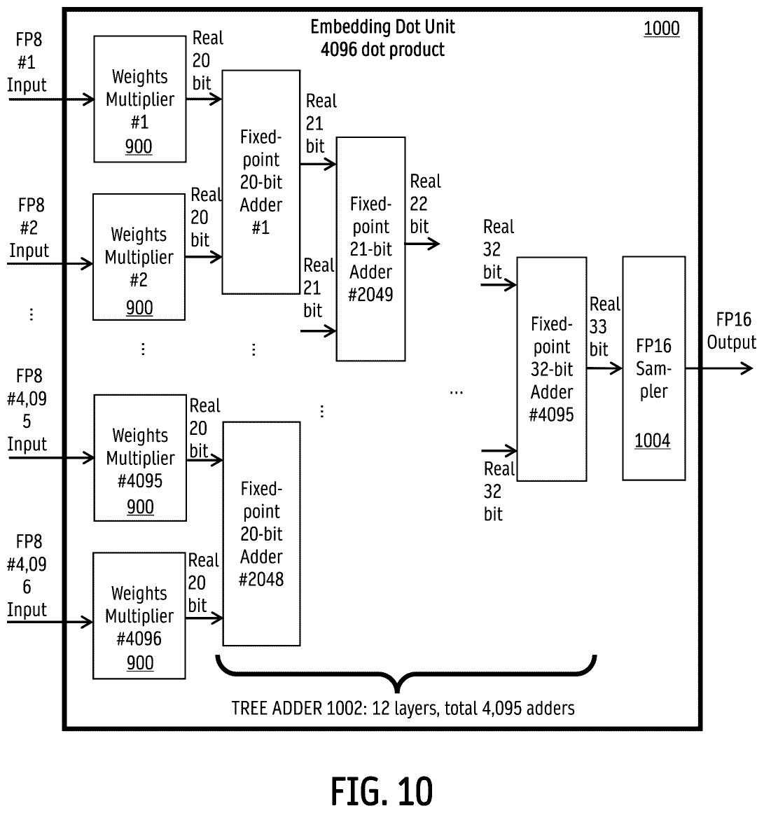

One or more chips of the AI cube can include one or more etched mind units (illustrated as EMUs 110 of FIGS. 1-2) corresponding to one or more transformer blocks (illustrated as transformers 308). The one or more chips of the AI cube can include circuitry such as one or more multipliers 204 and/or one or more multipliers 208. An exemplary implementation of a multiplier in one or more multipliers 204 is illustrated as weights multiplier circuit 900 of FIGS. 9-10. An exemplary implementation of a multiplier in one or more multipliers 208 is illustrated as attention multiplier circuit 600 of FIG. 6. Most operations in a transformer-based neural network involve matrix multiplication, and matrix multiplication consumes a significant amount of power and area if a generic matrix-to-matrix multiplication circuit is implemented. Notably, the one or more chips in the AI cube includes a highly power-efficient, predefined and fixed matrix multiplier. The matrix multiplier performs matrix multiplication through one or more vector dot product operations that multiply a vector having a predetermined size and predetermined bit representation and a further vector having a further predetermined size and a further predetermined bit representation. The power efficiency of the matrix multiplication circuit makes it feasible and practical to stack many chips together to form the AI cube.

The AI cube can offer a more efficient and environmentally friendly solution for executing LLM tasks. The AI cube can significantly reduce power consumption and accelerate machine learning inference. Due to the feedforward nature of the model, only one chip in the AI cube can be active at any given time, which can reduce power consumption. This feature can make the system more power-efficient, energy-efficient, lower operational costs, and contribute to a more sustainable AI solution. The unique design of this AI cube chip-stacking solution allows the solution to scale up or down to any model size needed. Each AI cube solution can be tailormade to hold a specific number of transformers, making it possible to build a model as large as necessary by adding more stacked chips. The scalability of the AI cube solution is a significant advantage, providing flexibility and adaptability to handle varying model sizes as per the requirements. Despite its powerful capabilities, the physical size of the AI cube solution is compact and minimal. The stacking design allows for a high degree of complexity in a very small space, making it possible to implement this technology even in smaller devices. The compactness of the AI cube solution is a significant advantage over other techniques which require larger area for equivalent computational power, making it an ideal choice for applications where area is a premium.

The stacked architecture and design of the AI cube solution addresses challenges of cost, high power consumption, and latency in AI inference. In some scenarios, AI models are stored in data centers and can require the loading of LLM weights onto a GPU for each inferencing task. Loading LLM weights onto the GPU can be both time-consuming and energy-intensive. The AI cube solution adds further advantages by leveraging die or package stacking. The AI model and LLM weights are not only embedded onto the hardware chip using the models-on-silicon solution, but the AI model and LLM weights are also strategically organized in a stacked configuration. As the data moves in a feedforward direction, the processing is sequential, and the order of the transformers or transformer blocks is based on the model architecture. The AI cube design approach can contribute to a significant reduction in the form factor of the device. The stacking of dies or packages can densely pack lots of computational power in a relatively small space. This feature makes it possible to transition AI from the voluminous server racks in data centers to much smaller, yet equally capable devices. The compact and efficient design of the AI cube stacked chips helps reduce power consumption and cost, while maintaining high computational efficiency and speed. Power consumption can be reduced because only one chip is enabled and active at a given time allowing a low-power and dense solution.

The potential applications for this technology are vast. By enabling AI to be incorporated into smaller devices, widespread adoption of AI can happen in numerous sectors including consumer electronics, healthcare, automotive, and more. The transition from data centers to compact devices could transform the way humans interact with and benefit from AI in everyday lives.

The AI cube solution revolutionizes AI hardware by incorporating not just the LLM weights and model (which can include activation functions, attention, embeddings, and transfer layers) onto the chip, but also utilizing a stacked die/package design. The AI cube could potentially transform the accessibility, applicability, and efficiency of AI technology. The AI cube solution holds the potential to revolutionize the accessibility, applicability, and efficiency of AI technology.

This AI cube stacking chip design can be tailored to encapsulate the LLM weights and inference architecture directly onto the hardware or silicon. AI cube having models-on-silicon technology not only eliminates the need for constant memory retrieval but also places the required data (SRAM, or ROM) close to the logic operations. Moreover, the memories are sequential, thus not requiring random-access. Each line is read in its designated time slot, along with the corresponding operation. Different from RAM like HBM where data is stored in random location and needs to be retrieved, in the AI cube, there is no address, since the weights are read line by line, per order (clock cycles). At each clock, the next line is read. There is no backward search, only forward feeding. This manner of reading the lines can be consistent throughout the execution of the model. This memory access approach can significantly enhance performance, simplify routing, and ensure rapid access to data, weights, and activations, making it a groundbreaking approach in LLMs hardware implementation.

The AI cube stacking architecture is made possible due to the feedforward nature of the transformer-based models. In a feedforward model, data moves in one direction—from input to output—without looping back. This feature can mean that at any given time, only one chip/die is active and performing computations. This sequential operation mode is a feature that effectively mitigates potential power consumption issues. With only one chip working at a time, the system does not face the power challenges associated with large-scale computations in a dense package, making it an efficient and sustainable solution for scaling large language models.

The AI cube solution can bring about an increase in performance, simplification in routing, and also can introduce a power-efficient approach to model scaling. The AI cube solution has a unique combination of attributes and features that makes the stacking solution a game-changer in the implementation of LLMs.

### Exemplary Models-On-Silicon Chip Architecture

FIG. 1 illustrates an exemplary chip architecture, according to some embodiments of the disclosure. FIG. 2 illustrates exemplary details within the parts of the exemplary chip architecture, according to some embodiments of the disclosure. Models-on-silicon chip 100 is depicted in both figures to illustrate exemplary implementations.

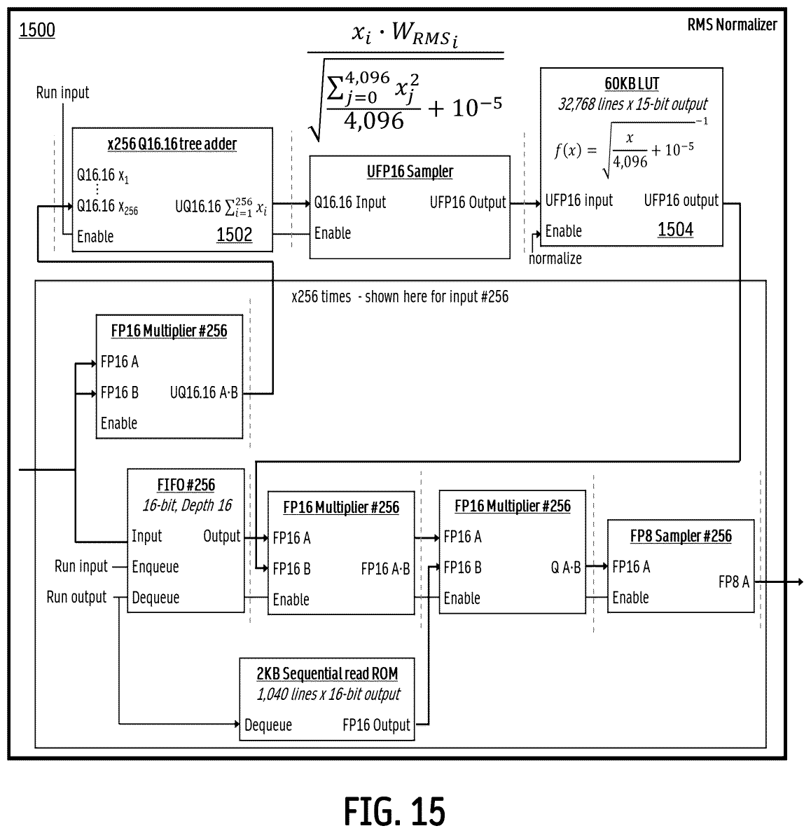

A “models-on-silicon” chip 100 illustrated in FIGS. 1-2 may include one or more of: embedder circuit 102, RMS normalizer circuit 104, flow control circuit 106, sampler circuit 108, and one or more etched mind units 110 (EMUs). Exemplary implementations of embedder circuit 102 are illustrated in FIG. 14. Exemplary implementations of RMS normalizer circuit 104 are illustrated in FIG. 15. Exemplary implementations of sampler circuit 108 are illustrated in FIGS. 16-17.

An EMU of one or more etched mind units 110 may include one or more of: one or more rotary embedder circuits 112, one or more SILU activator circuits 114, one or more SoftMax circuits 118, one or more embedding dot unit circuits (EDUs) 116, one or more attention dot unit circuits (ADUs) 120.

In one implementation, an EDU of the one or more embedding dot unit circuits may carry out a (4096-elements) dot product operation between FP8 embedding vector and FP6 weights vector stored in one or more ROMs 130, e.g., every cycle. The dot product operation can be performed using one or more tree adders 202 and one or more multipliers 204 in the EDU.

In one implementation, an ADU of the one or more attention dot unit circuits 120 may carry out a (128-elements) dot product operation between FP16 input vector and FP16 K or V vector cached in one or more SRAMs 140, e.g., every cycle. The dot product operation can be performed using one or more tree adders 206 and one or more multipliers 208 in the ADU.

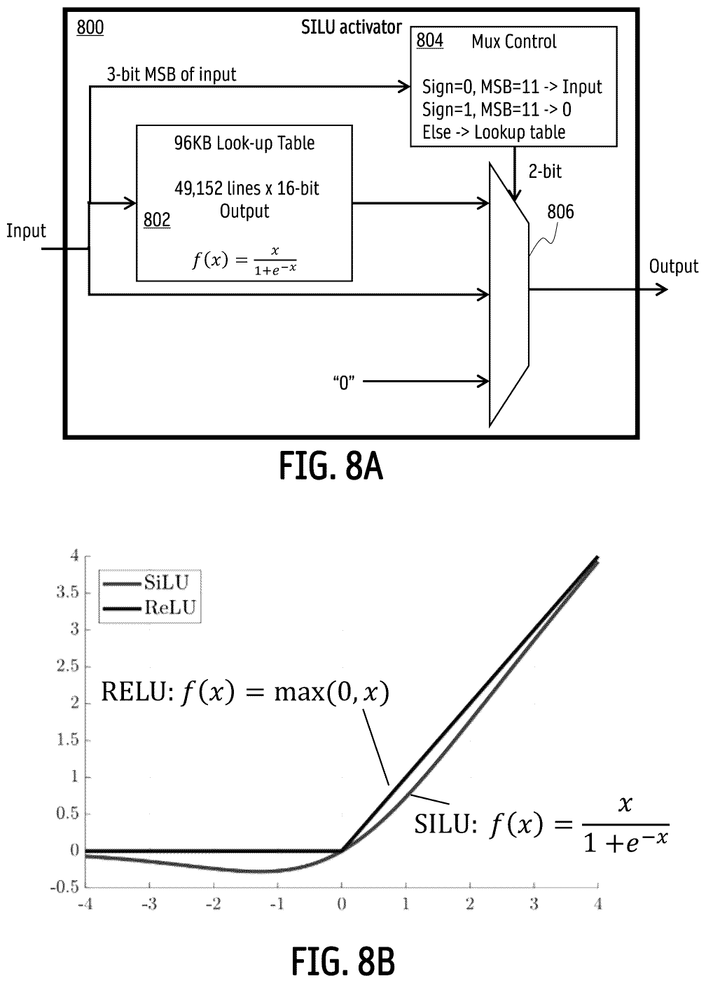

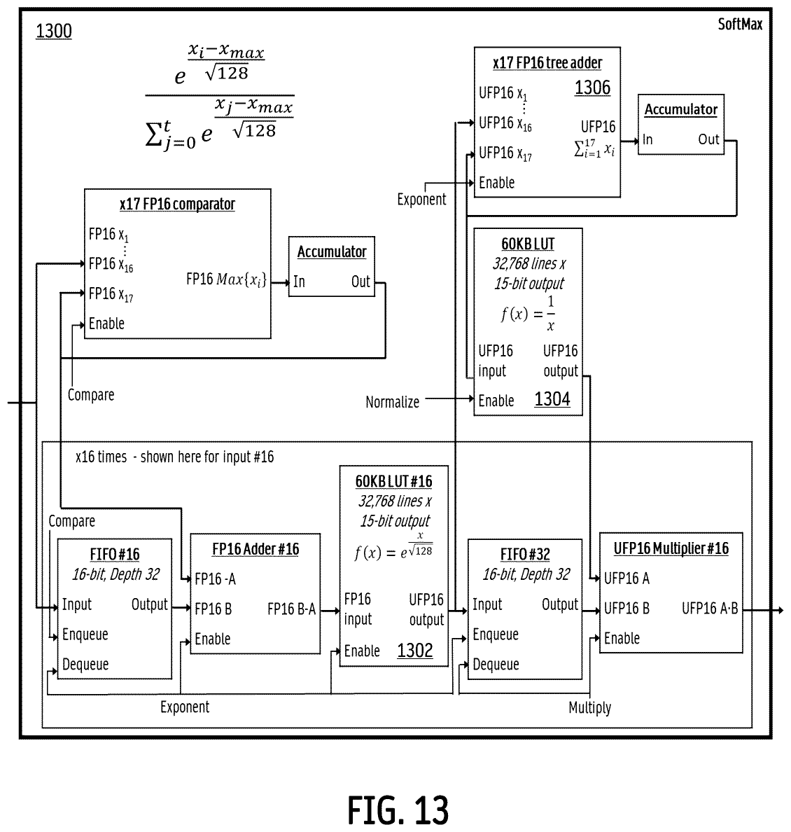

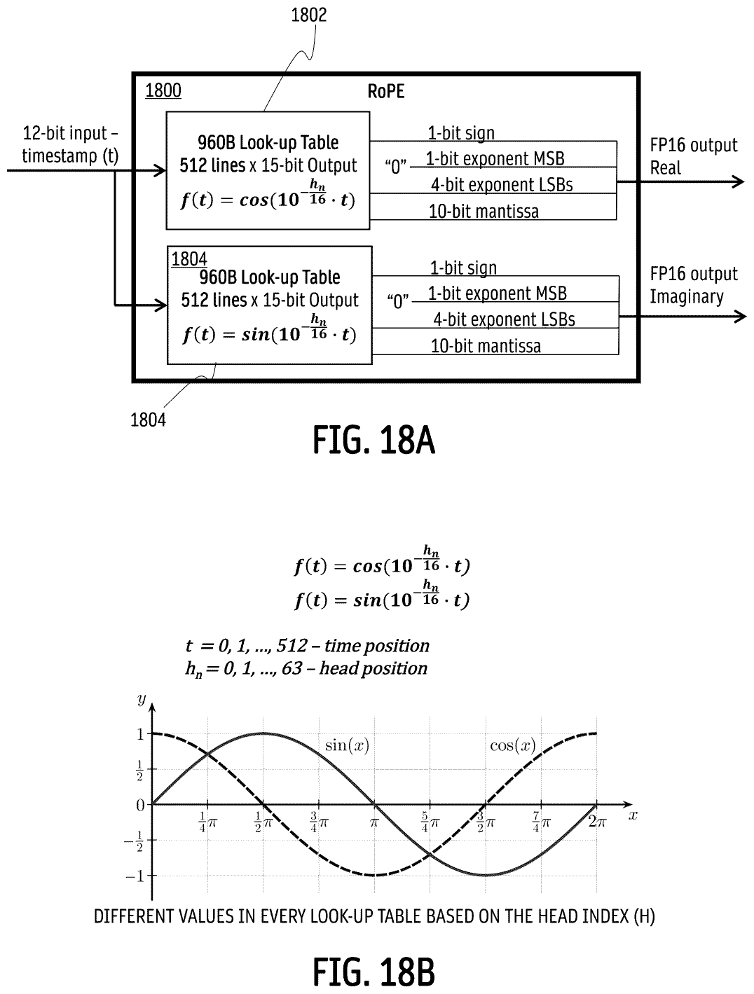

Exemplary implementations of one or more rotary embedder circuits 112 are illustrated in FIGS. 18A-18B. Exemplary implementations of one or more SILU activator circuits 114 are illustrated in FIGS. 8A-8B. Exemplary implementations of one or more SoftMax circuits 118 are illustrated in FIG. 13. Exemplary implementations of one or more EDU circuits 116 are illustrated in FIGS. 9-10. Exemplary implementations of one or more ADU circuits 120 are illustrated in FIG. 6.

An EDU of one or more EDU circuits 116 can include one or more tree adders 202. The EDU may include one or more multipliers 204. A multiplier in one or more multiplier 204 may multiple two values, such as two floating-point values. For example, one or more multipliers 204 may include an FP4/FP6 multiplier. One or more multipliers 204 may include an FP4/FP8 multiplier, one or more multipliers 204 may include an FP6/FP8 multiplier. One or more multipliers 204 may be specifically designed to perform multiplication of values or data having predetermined representations (e.g., FP4, FP6, FP8, FP12, INT8, etc.). One or more multipliers 204 may read data from one or more ROMs 130. One or more tree adders 202 may add multiplication results produced by one or more multipliers 204 together.

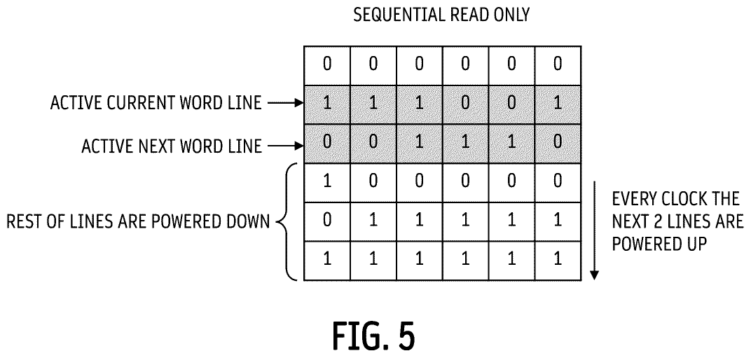

An EMU of one or more etched mind units 110 may include one or more ROMs 130 that can store and provide data to one or more circuits performing logic operations in an EDU of EDU circuits 116. One or more ROMs 130 may include one or more sequential read-only memories, which may be placed in proximity to the circuits performing logic operations in the EDU. Exemplary implementations of the one or more ROMs 130 are illustrated in FIG. 5.

An ADU of one or more ADU circuits 120 can include one or more tree adders 206. The ADU may include one or more multipliers 208. A multiplier in one or more multiplier 204 may multiple two values, such as two floating-point values. For example, one or more multipliers 208 may include an FP16/FP16 multiplier. One or more multipliers 208 may be specifically designed to perform multiplication of data having predetermined representations (e.g., FP4, FP6, FP8, FP12, FP16, INT8, etc.). One or more multipliers 208 may read data from one or more SRAMs 140. One or more tree adders 206 may add multiplication results produced by one or more multipliers 208 together.

An EMU of one or more etched mind units 110 may include one or more SRAMs 140 that can store and provide data to one or more circuits performing logic operations in an ADU of ADU circuits 120. One or more SRAMs 140 may include one or more sequential read/write memories, which may be placed in proximity to the circuits performing logic operations in the ADU.

In some embodiments, models-on-silicon chip 100 is a model-specific integrated circuit. The integrated circuit includes a sequential read-only memory (e.g., one or more ROMs 130) to store one or more weight values of a weight matrix of a transformer-based neural network. The integrated circuit includes one or more circuits to perform one or more operations of an inferencing task of the transformer-based neural network (e.g., various circuits illustrated in FIGS. 1-2). The integrated circuit includes a sequencer circuit to orchestrate the one or more circuits according to a predetermined timing sequence of the transformer-based neural network (e.g., flow control circuit 106).

Flow control circuit 106 (also referred to as a sequencer circuit) plays a role in orchestrating various circuits to execute operations according to a predetermined timing sequence. Advantageously, a transformer-based neural network operates in a feedforward manner. The sequence of operations of the transformer-based neural network corresponding to different layers of the neural network can be determined and mapped into a timing sequence of operations. The timing sequence of operations may include stages of operations, one following another. In a particular time slot or stage in the timing sequence, data can be moved in, processed, and moved out to be processed in the next/following time slot, in a feedforward, progressive manner. Flow control circuit 106 thus can implement digital logic to generate clock edges/signals (e.g., control signals, timing signals, enable signals, disable signals, trigger signals, etc.) to orchestrate operations to be performed according to the timing sequence. Flow control circuit 106 can control data flow into and/or out of the one or more circuits. Flow control circuit 106 can enable and/or disable the one or more circuits according to a predetermined timing sequence.

According to one aspect, the models-on-silicon chip 100 illustrated in FIGS. 1-2 provides and implements at least a part of or an entire generative AI model (e.g., a transformer-based neural network, an LLM, etc.) in a single chip or integrated circuit. This involves integrating the generative AI model into a single chip, e.g., as illustrated as models-on-silicon chip 100 in FIGS. 1-2. The chip 100 receives tokens in and outputs tokens out. The entire architecture, weights, and flow of the generative AI model can be embedded into the chip 100.

In one exemplary implementation where chip 100 embeds a specific transformer-based neural network, there are 32 instances of EMUs 110 on models-on-silicon chip 100. In an EMU, there may be 4 instances of SILU activator circuit 114. An instance of SILU activator circuit 114 may include a look up table 220, e.g., a 96 Kilobyte (KB) look up table. In an EMU, there may be 4 instances of rotary embedder circuit 112. An instance of rotary embedder circuit 112 may include a look up table 230, e.g., 2 KB look up table. In an EMU, there may be 8 instances of EDU circuit 116. In an EMU, there may be 16 instances of ADU circuit 120.

An instance of an EDU may include tree adder 202, e.g., a tree adder to add 4096 inputs. An instance of an EDU may include 4096 instances of multiplier 204. An instance of EDU may include 4096 instances of sequential read-only memory 130, e.g., 4.6 KB sequential read-only memory. A sequential read-only memory may be provided for an individual multiplier, e.g., in proximity to the multiplier. In total, one or more EDU circuits 116 may include 4.6 Gigabytes (GB) of sequential read-only memory, and 1,048,576 multiplier circuits and adder circuits.

An instance of an ADU may include tree adder 206, e.g., a tree adder to add 128 inputs. An instance of an ADU may include 128 instances of multiplier 208. An instance of ADU may include 128 instances of sequential read/write memory 140, e.g., 4 KB sequential read/write memory. A sequential read/write memory may be provided for an individual multiplier, e.g., in proximity to the multiplier. In total, one or more ADUs may include 256 Megabytes (MB) of sequential read/write memory, and 65,536 multiplier circuits and adder circuits.

According to one aspect, the chip 100 illustrated in FIGS. 1-2 has the actual components, blocks, and parts that make up the operations of an inference task of a transformer-based neural network model architecture. The chip 100 thus includes circuits that implement one or more transformer blocks. The circuits may implement various operations in a transformer block, e.g., SoftMax, attention, RMS normalizer, etc. For example, embedding the chip with an open-source model would mean that the way the hardware blocks are connected to each other on the chip would match the architecture of the open-source model.

FIG. 3 illustrates embedding an exemplary open-source model onto the chip, according to some embodiments of the disclosure. As illustrated, the model includes one or more functional blocks, such as tokenizer 330, embedder 302, RMS normalizer 304 operating on weights vector 306, one or more transformers 308 (e.g., 32 transformer blocks), matrix multiply 310 operating on weight matrix 312, and sampler 314 (e.g., deterministic sampler). Some functional blocks of the model, such as embedder 302, RMS normalizer 304 operating on weights vector 306, one or more transformers 308, matrix multiply 310 operating on weight matrix 312, and sampler 314, as seen in FIG. 3 can be embedded as circuits onto the models-on-silicon chip 100, as illustrated in FIGS. 1-2.

Input data (e.g., input words) may be tokenized by tokenizer 330, and input tokens may be output by tokenizer 330. The input tokens (e.g., an input token may be represented as a 15-bit integer) may be provided as input to embedder 302. Embedder 302 may include one or more look up tables. Embedder 302 may output a vector (e.g., a vector having 4096 values). In some embodiments, the values of the vector are FP16 values. The vector may be provided as input to RMS normalizer 304. RMS normalizer 304 may perform the function:

$$\frac{{x}_{i} \cdot {W}_{{RMS}_{i}}}{\sqrt{\frac{{\sum }_{j = 0}^{4 , 096} {x}_{j}^{2}}{4 , 096} + {10}^{- 5}}}$$

RMS normalizer 304 may read weights vector 306 (Wₙ₃ weights vector having 4096 values) from a sequential read-only memory. In some embodiments, the values of weights vector 306 are FP6 values. RMS normalizer 304 may output a vector (e.g., a vector having 4096 values). In some embodiments, the values of the vector are FP8 values. The vector may be processed by one or more transformers 308, which may output a vector (e.g., a vector having 4096 values) to be processed by matrix multiply 310. In some embodiments, the values of the vector of FP8 values. Matrix multiply 310 may read weight matrix 312 (W_{cls} weight matrix (e.g., a matrix having FP6 values) a sequential read-only memory. Matrix multiply 310 may perform matrix multiplication between the vector from one or more transformers 308 and weight matrix 312. Matrix multiply 310 may output a vector (e.g., a vector having 128,256 values). In some embodiments, the values of the vector may include FP16 values. The vector is passed onto sampler 314 to get an index of the largest number in the vector and output an output token (e.g., an output token may be represented as a 15-bit integer). The output token may be looped back as an input to embedder 302, since the model is auto-regressive. Timestep may increase by 1 to trigger the model to produce the next output token.

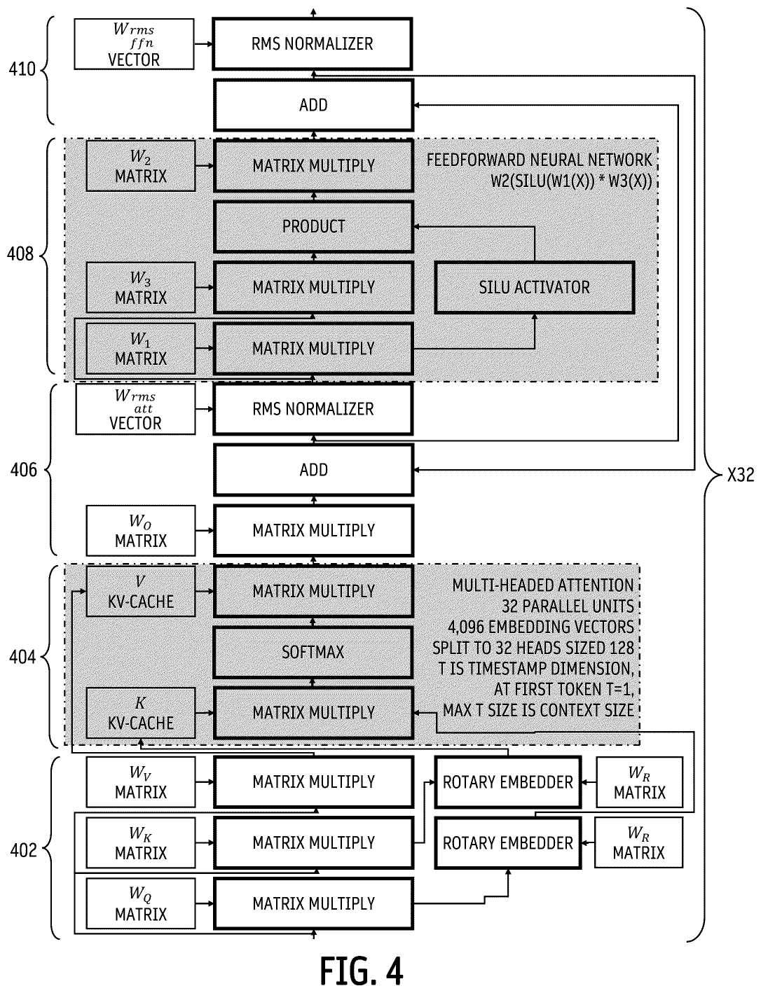

FIG. 4 illustrates exemplary hardware blocks or circuits representing and corresponding to an exemplary open-source model, according to some embodiments of the disclosure. Specifically, the one or more transformers 308 seen in FIG. 3 are depicted in greater detail in FIG. 4. The functional blocks of the one or more transformers 308 (e.g., representing one or more operations of an inferencing task of a transformer-based neural network) seen in FIG. 3, such as matrix multiply, rotary embedder, SoftMax, add, RMS normalizer, SILU activator, and product, can be embedded onto the chip as the circuits as illustrated in FIGS. 1-2. Specifically, the functional blocks can be implemented in hardware as an EMD (e.g., one or more etched mind units 110 seen in FIGS. 1-2). In some implementations, there are 32 transformers, and thus the 32 transformers can be implemented in hardware as 32 EMDs. The weight vectors and matrices can be stored in sequential read-only memories (e.g., one or more ROMs 130) as depicted in FIGS. 1-2. The KV-cache can be stored in sequential read/write memories (e.g., one or more SRAMs 140) as depicted in FIGS. 1-2. The functional blocks of one or more transformers 308 thus can be directly implemented as circuits on the chip, and the sequencer circuit can configure the circuits corresponding to the functional blocks to operate according to the data and operational flow illustrated in FIG. 4. The circuits (e.g., hardware blocks) of the EMU are coupled to each other according to the data and operational flow as illustrated in FIG. 4.

A rotary embedder seen in FIG. 4 may implement the following functions:

$$f ( {x}_{i} ) = {x}_{i} \cdot {w}_{r} - {x}_{i + 1} \cdot {w}_{i}$$

$$f ( {x}_{i + 1} ) = {x}_{i} \cdot {w}_{i} + {x}_{i + 1} \cdot {w}_{r}$$

A SoftMax block seen in FIG. 4 may implement the following:

$$\frac{{e}^{\frac{{x}_{i} - {x}_{max}}{\sqrt{128}}}}{{\sum }_{j = 0}^{t} {e}^{\frac{{x}_{j} - {x}_{max}}{\sqrt{128}}}}$$

An add block seen in FIG. 4 may implement element-wise addition:

$$f ( x , y ) = x + y$$

A product block seen in FIG. 4 may implement element-wise multiplication:

$$f ( x , y ) = x \cdot y$$

A SILU activator block seen in FIG. 4 may implement the following:

$$f ( x ) = \frac{x}{1 + {e}^{- x}}$$

The data and operational flow illustrated in FIG. 4 can include different groups of operations, e.g., group 402, group 404, group 406, group 408, and group 410, being performed or arranged in a feedforward manner. Group 402 includes two rotary embedders and three matrix multiply blocks. Group 402 may be embedded onto models-on-silicon chip 100 as one or more rotary embedder circuits 112 and one or more EDU circuits 116. Group 404 includes two matrix multiply blocks and a SoftMax block. Group 404 may be embedded onto models-on-silicon chip 100 as one or more ADU circuits 120 and one or more SoftMax circuits 118. Group 406 includes a matrix multiply block, an add block, and an RMS normalizer block. Group 406 may be embedded onto models-on-silicon chip 100 as one or more EDU circuits 116, and RMS normalizer circuit 104. Group 408 includes three matrix multiply blocks, a SILU activator block, and a product block. Group 408 may be embedded onto models-on-silicon chip 100 as one or more EDU circuits 116 and one or more SILU activator circuits 114. Group 410 includes an add block and an RMS normalizer block. Group 408 may be embedded onto models-on-silicon chip 100 as one or more EDU circuits 116 and RMS normalizer circuit 104.

### Sequential Read-Only Memory

FIG. 5 illustrates sequential read-only (SRO) memory, according to some embodiments of the disclosure. According to one aspect, the models-on-silicon chip has one or more instances of SRO memories. SRO memory is a type of memory storage, utilizing ROMs, that allows data to be read sequentially but not written or modified after the values have been etched onto the ROM. The rest of the ROM can be shutdown to reduce power and area. In some embodiments, the models-on-silicon chip has one or more SRO memories. The SRO memory powers up an active current word line and an active next word line at a time, while other word lines can be powered down. The active current word line refers to the word line having data being used or processed by a circuit to perform an operation during a time slot in the predetermined timing sequence. The active next word line refers to the word line having data being used or processed by the circuit to perform an operation during a further/next time slot in the predetermined timing sequence. The SRO memory can power down the rest of the word lines, or the rest of the word lines in the SRO memory can remain powered down. At the next clock or time slot, the active current word line is powered down, the active next word line is already powered up, and a further active next word line is powered up. At every clock or time slot, two word lines are powered up in the SRO memory. The two active word lines that are powered up gets moved by one word line down the SRO memory at every clock or time slot.

In some embodiments, one or more SRO memories may be provided on the chip to store various weight matrices for a transformer model:

| Num. Lines | Layer | Matrix |
|---|---|---|
| 16 | 0 | Wq |
| 4 | 0 | Wk |
| 4 | 0 | Wv |
| 16 | 0 | Wo |
| 112 | 0 | W1 or W3 |
| 56 | 0 | W2 |
| . . . | . . . | . . . |
| 16 | 31 | Wq |
| 4 | 31 | Wk |
| 4 | 31 | Wv |
| 16 | 31 | Wo |
| 112 | 31 | W1 or W3 |
| 56 | 31 | W2 |
| 16 | 31 | Wq |
| 501 | — | Wcls |

There may be 1,048,576 Weights ROMs (e.g., SRO memories) in models-on-silicon chip 100 illustrated in FIGS. 1-4. A ROM can hold weights in FP6 format. A ROM output can be a 6-bit value. A weights ROM can hold a specific weight matrix column, since a weights ROM can output a single number out of the 4096-element vector being multiplied in the EDU. A weights ROM can hold one of 256 weight matrix rows, since there are 256 EDUs working in parallel and producing 256 numbers per clock cycle. A ROM can hold matrix rows 1, 257, . . . , and another ROM can hold matrix rows 2, 258, and so forth. In some cases, a weights ROM can hold elements from (all) weights matrices in (all) layers, since a weights ROM sequentially outputs the number the matrix multiplier is using for (all) transformers and matrices, as the weights multipliers are shared across all layers and weights matrices. The weights ROM hold (only) the linear layers' weights. There may be one or more dedicated ROMs for the embedder and RMS normalizer units.

### Sequential Read/Write Memory in an Attention Multiplier Circuit

FIG. 6 illustrates sequential read/write (SRW) memory used in attention multiplier circuit 600, according to some embodiments of the disclosure. According to one aspect, the models-on-silicon chip has one or more SRW memories. The SRW memory involves using an SRAM in a special configuration that it is not dynamically readable, but is built up sequentially to reduce power and area. An SRAM that can be read sequentially and/or written sequentially has drastically simplified logic and circuitry for reads and/or writes. An SRW memory can be used with or in an attention dot unit to supply weights to attention multiplier circuit 600. Attention multiplier circuit 600 may be a part of an ADU. In one implementation, the ADU having the attention multiplier circuit 600 may receive an input number and multiplies it by a number from SRAM (e.g., SRW memory) every clock cycle. 64 SRAMs can be used to store the 32 layers and K vs. V separately, so the SRAM can read lines sequentially.

According to one aspect, the SRW memory may be referred to as Key-Value Static Random-Access Memory (KV SRAM), which can store data in key-value pairs. KV SRAM can enable storing the attention history (e.g., cached keys and values) of a transformer block.

Referring back to FIG. 6, the models-on-silicon chip includes an attention dot unit (shown as attention multiplier) as illustrated by FIG. 6. The attention dot unit may receive an input number and multiplies it by a number from SRAM-every clock cycle. 64 SRAMs are used to store the 32 layers and K vs. V separately, so the SRAM can read lines sequentially.

In some embodiments, a models-on-silicon chip has a sequential read/write memory to store a key-value cache for the transformer-based neural network. To improve computational efficiency, one or more key-value caches can be included on chip with the ADUs to enhance the performance of the transformer-based neural network by temporarily storing frequently accessed data. Keys and values computed in the attention mechanism can be cached to allow for rapid retrieval of information. In the context of transformer-based neural networks, the key typically represents a unique identifier for a specific input or query, while the value contains the corresponding output or computational result. This caching mechanism deals with dynamic data, and thus uses read/write memory, such as SRAM. The key-value cache can significantly reduce latency and computational overhead by avoiding redundant calculations and data fetching, thereby improving the efficiency and responsiveness of the model during inference. Because the cached keys and values can be written and read sequentially during inference, the SRAM implementation can be simplified by restricting reads and writes to be done in a sequential manner (obviating circuits that allow for random-access).

Attention multiplier circuit 600 may have the following exemplary specification:

Attention Multiplier
Description
Receives an input number and multiplies it by a
number from SRAM - every clock cycle.
64 SRAMs are used to store the 32 layers and K
vs. V separately, so the SRAM can read lines
sequentially.
Inputs

| | | | |
|---|---|---|---|
| Q or KQ number | FP16 | 16 | b |
| K or V number | FP16 | 16 | b |
| K/V | Control | 1 | b |
| Layer | Control | 5 | b |
| Rd - SRAM read | Control | 1 | b |
| Wr - SRAM write | Control | 1 | b |
| L - SRAM line to write | Control | 5 | b |
| Store Q/QK | Control | 1 | b |
| On/Sleep | Control | 1 | b |

Outputs

| | | | |
|---|---|---|---|
| Multiplication | Q16.16 | 32 | b |

Details
Based on the layer and if multiplying K or V, the decoder
604 turns on one of the 64 SRAMs 602.
Number from SRAM read sequentially (line by line). Since
there are 16 ADUs per head, (only) 32 lines are needed
(out of up to 512 context).
Output is a 32-bit fixed-point so adders can use it.

| | |
|---|---|
| Instances | 65,536 (32 heads × 16 |
| | dot/head × 128) |

Attention multiplier circuit 600 may be included in an ADU to perform multiplication of two numbers (e.g., FP16 value and FP16 value), where one of the two numbers is read from the sequential read/write memory storing the key-value cache. As illustrated, attention multiplier circuit 600 includes 64 SRW memories 602, and decoder 604 may turn on one of the 64 SRW memories 602 to be used. Data is read from the active SRW memory serially, e.g., line by line. The data the active SRW memory is multiplied against the input by multiplier 606.

Many instances of attention multiplier circuit 600 may be included in an ADU to perform element-wise multiplication, e.g., in parallel. The multiplication results of the instances of attention multiplier circuit 600 can be summed by a tree adder to form a vector dot product result. The ADU may perform many vector dot products to form a final matrix multiplication result.

### Activator Circuits: Exponent Unit Circuit and Sigmoid Linear Unit Activator Circuit

In some embodiments, the models-on-silicon chip has one or more read-only memories to store one or more look up tables for approximating one or more functions, e.g., f(x). The look up tables can store precomputed values of a function, f(x). The precomputed values may correspond to one or more values or segments over a range of values of an input number, x. The input number, x, can be used as an index or address to look up and obtain a precomputed value, f(x), from the look up table. The precomputed values can be stored in a ROM. The functions that are a part of the transformer-based neural network are established ahead of time, and thus it is possible to construct look up tables with precomputed values. Compute calculations can be avoided during real-time inference, which saves power and reduces latency.

Examples of a function may include activation functions. Activation functions introduce non-linearity into the model, enabling it to learn complex patterns. An example of an activation function includes the RELU, which outputs the input directly if it is positive and zero otherwise, thus helping to mitigate the vanishing gradient problem. Another example of an activation function includes the SILU function, which maps input values to a range between 0 and 1, is often used in binary classification tasks. Another example of an activation function includes the Hyperbolic Tangent (Tanh) function, similar to SILU but with outputs ranging from −1 to 1, is useful for centering data. Another example of an activation function includes Leaky RELU, which allows a small gradient when the input is negative. Another example of an activation function includes the Swish function, defined as x·sigmoid(x), which has shown to improve model performance by providing smoother gradients and better convergence properties.

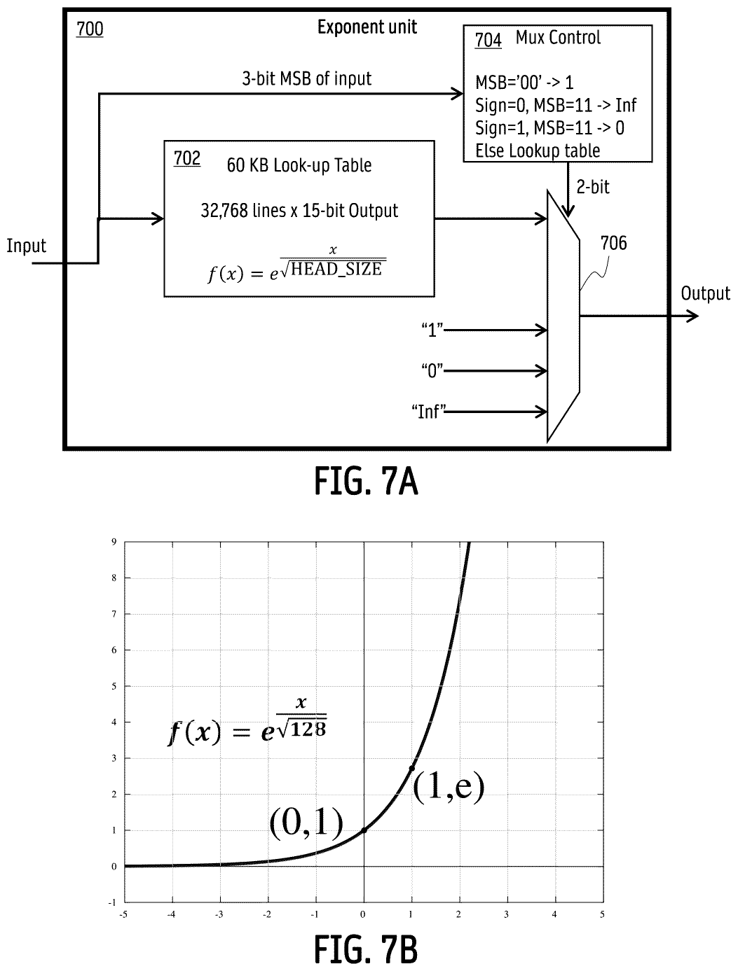

FIG. 7A illustrates exponent unit circuit 700, according to some embodiments of the disclosure. FIG. 7B illustrates an exponent function approximated by exponent unit circuit 700, according to some embodiments of the disclosure. Exponent unit circuit 700 includes a read-only memory to store a look up table 702 having one or more precomputed values of an exponent function:

$$f ( x ) = {e}^{\frac{x}{\sqrt{HEAD\_SlZE}}}$$

In some cases, exponent unit circuit 700 includes mux control 704 and mux 706. Mux control 704 may check whether the input value meets a particular condition, and selects a particular value to use as the output of exponent unit circuit 700. Mux control 704 may output a 2-bit value as selection signal for mux 706, to select one of four possible values to use as the output.

For example, if the most significant bits (MSBs) of the input are “00”, then the value of “1” is selected by mux 706 to use as the output. If the sign bit is 0 and the MSBs of the input are “11”, then the value of “Inf” (positive infinity) is selected by mux 706 to use as the output. If the sign bit is 1 and the MSBs of the input are “11”, then the value of “0” is selected by mux 706 to use as the output. Otherwise, the value from look up table 702 is used as the output.

FIG. 8A illustrates a SILU activator circuit 800, according to some embodiments of the disclosure. FIG. 8B illustrates a sigmoid linear unit function and a RELU function, according to some embodiments of the disclosure. SILU activator circuit 800 includes a read-only memory to store a look up table 802 having one or more precomputed values of a SILU function:

$$f ( x ) = \frac{x}{1 + {e}^{- x}}$$

In some cases, SILU activator circuit 800 includes mux control 804 and mux 806. Mux control 804 may check whether the input value meets a particular condition and selects a particular value to use as the output of SILU activator circuit 800. Mux control 804 may output a 2-bit value as selection signal for mux 806, to select one of three possible values to use as the output.

For example, if the sign bit is 0 and the MSBs of the input are “11”, then the input is selected by mux 806 and passed on to use as the output. If the sign bit is 1 and the MSBs of the input are “11”, then the value of “0” is selected by mux 806 to use as the output. Otherwise, the value from look up table 802 is used as the output.

### Weights Multiplier Circuit in Embedding Dot Unit Circuit

One operation of an inferencing task of a transformer-based neural network involves multiplying an embedding vector with a weight matrix. The embedding vector can represent a particular token, and various weight matrices of the transformer-based neural network are used to transform the embedding vector as the embedding vector progresses through the transformer-based neural network. The embedding vector is a vector representation of a token, and can be a dense, high-dimensional vector that encodes various types of information about the token, such as semantic information, syntactic information, contextual information, and positional information about the token. The weight matrix has weight values which have been learned through training to transform an embedding vector to extract patterns and relationships in the data.

Because the vector-to-matrix multiplication operation to be performed in models-on-silicon is known, the one or more circuits can include a custom-built embedding dot unit circuit that can perform the multiplication of the embedding vector with a weight matrix with low-power. The custom-built embedding dot unit circuit can be designed to perform vector dot products. Multiplying an embedding vector having 1 by X elements with a weight matrix having X by Y elements involves calculating Y vector dot products and producing an output vector having Y elements (the output vector having the Y vector dot products). Each vector dot product is a dot product of the embedding vector with a column vector of the weight matrix (or a row vector of the weight matrix).

To calculate the vector dot product, element-wise multiplication of values in the embedding vector and values in a column/row vector of the weight matrix is performed, and the multiplication results are added together to form a value in the output vector. A number of multiplier circuits multiplying two floating-point numbers (e.g., an embedding value in the embedding vector and a weight value in the weight matrix) can be implemented to perform the element-wise multiplication of values for the vector dot product, e.g., in parallel. A tree adder circuit can be implemented to sum the multiplication results. Because the multiplication operation of an embedding value in the embedding vector with a weight value of the weight matrix is established ahead of time, a custom-built multiplier circuit to multiply the embedding value and the weight value may be implemented, such as a multiplier circuit that performs a specific task of FP8×FP6 multiplication (e.g., the embedding value may be an FP8 value, and the weight value may be an FP6 value).

According to one aspect, the models-on-silicon chip illustrated in FIGS. 1-4 has optimized physical layout and design. Matrix multiplications are predefined and known, and digital circuits, such as the EDU, can be designed and implemented to perform a specific type of matrix multiplication. Also, the format of the values being operated on are also predefined and known, so custom-built multiplier circuits can be designed and implemented to perform a specific type of multiplication of two values. For example, weights multiplier circuit 900 illustrated in FIG. 9 to be used in an EDU may be predefined and built with one specific task in mind (e.g., FP8×FP6 multiplication). In addition, at least SRO memory 904 is placed in proximity to multiplication circuit 908.

In some embodiments, the models-on-silicon chip includes weights multiplier circuit 900 (e.g., many instances of weights multiplier circuit 900). Weights multiplier circuit 900 can multiply an embedding value of an embedding vector of the transformer-based neural network and a weight value of a weight matrix of the transformer-based neural network. Weights multiplier circuit 900 may include multiplication circuit 908 to perform multiplication of an FP6 number (e.g., a weight value) and an FP8 number (an embedding value). Multiplication circuit 908 is designed with one specific task, to multiply an FP8 value and an FP6 value. The custom circuitry of multiplication circuit 908 means that the circuitry is simpler and consumes less power than other generic multiplication circuits.

Weights multiplier circuit 900 includes SRO memory 904 to store weights (e.g., weight values of a weight matrix). In some embodiments, weights multiplier circuit 900 may include SRAM 902. SRAM 902 may include a small read/write memory to store additional weight values that can be used in place of the etched weight values on SRO memory 904 (e.g., thus bypassing the etched weight values on SRO memory 904).

In some embodiments, SRAM 902 may store one or more weight values of a low-rank weight matrix. The transformer-based neural network may have pre-trained weights that are stored and etched in SRO memory 904. The transformer-based neural network may be fine-tuned using a Low-Rank Adaptation (LoRA) technique, where a low-rank weight matrix (a much smaller matrix than the original weight matrix) can be trained and updated so that the transformer-based neural network can perform a specific task. One or more tree adders 202 may add multiplication results produced by one or more multipliers 204 together.

In LoRA, the original weight matrix W can be decomposed into smaller low-rank matrices A and B, where ΔW=B·A. A low-rank weight matrix may be based on the original weight matrix W. A low-rank weight matrix may approximate the original weight matrix W. A low-rank weight matrix may capture significant features of the original weight matrix W while discarding less important features. A low-rank weight matrix may be a compressed version of the original weight matrix W. A low-rank weight matrix may have fewer linearly independent rows or columns when compared to the original weight matrix W. During fine-tuning, the weight values of the low-rank, smaller weights matrices A and B are updated, and not the weight values of the original weight matrix W. The weight values of the low-rank weight matrix can be stored in SRAM 902 to offer some flexibility for the models-on-silicon chip to implement a fine-tuned transformer-based neural network. In some implementations, a 2% LoRA update can be implemented to offer some flexibility. An application processor may write one or more weight values of the low-rank matrix onto SRAM 902.

In some embodiments, SRAM 902 may store one or more repair weight values. If there are one or more errors or faulty values in SRO memory 904 (the errors or faulty values can occur when values are being etched onto SRO memory 904), the errors or faulty values can be corrected by storing correct values, e.g., one or more repair weight values, in SRAM 902. The one or more repair weight values may correct one or more etched weight values.

Weights multiplier circuit 900 may include mux 906, SRAM 902, and SRO memory 904. Mux 906 can be used to select an output from SRAM 902 or an output from SRO memory 904 to be used as an input to multiplication circuit 908. Advantageously, mux 906 allows bypassing of a value read from SRO memory 904, and using the value from SRAM 902 to be used instead as the input to multiplication circuit 908. If selected by mux 906, multiplication circuit 908 may perform multiplication of a weight that is read from SRO memory 904. If selected by mux 906, multiplication circuit 908 may perform multiplication of a weight that is read from SRAM 902, such as a weight value of a low-rank weight matrix, or a repair weight value.

FIG. 10 illustrates embedding dot unit circuit 1000, according to some embodiments of the disclosure. According to one aspect, the models-on-silicon chip includes one or more instances of embedding dot unit circuit 1000. Embedding dot unit circuit 1000 can perform elements dot product operation between an embedding vector (e.g., FP8 embedding vector) and a weights vector (e.g., FP6 weights vector read from SRO memory) every cycle. Embedding dot unit circuit 1000 may include one or more instances (e.g., 4096 instances) of weights multiplier circuit 900. The instances of weights multiplier circuit 900 may perform multiplication in parallel. The outputs (e.g., 4096 outputs) may be added together by tree adder circuit 1002 of embedding dot unit circuit 1000. Embedding dot unit circuit 1000 may include tree adder circuit 1002 to add one or more multiplication results produced by one or more instances of weights multiplier circuit 900. In an implementation that adds 4096 numbers together, tree adder circuit 1002 may include 12 layers of adders and a total of 4095 adders. To sum all the multiplication results and receive a fused multiple add effect, tree adder circuit 1002 can implement a tree or hierarchical structure (and not a recursive structure) to add multiple input simultaneously and efficiently. In some embodiments, tree adder circuit 1002 uses a special fixed-point adder with a relatively large number of bits (e.g., 20 bits, 21 bits, . . . 32 bits), and uses a sampler 1004 to resample the final sum into a floating-point representation. Embedding dot unit circuit 1000 may generate an FP16 output. Using a large number of bits in tree adder circuit 1002 can prevent overflow during many stages/layers of adding.

### Power and Clock Gating

According to one aspect, the models-on-silicon chip can implement power/clock gating of one or more hardware components/blocks when not in use. In addition, using purpose-built SRO memories and SRW memories, it is possible to shut most of the memory off when only one line is needed for a given operation. In some cases, power and clock gating can be implemented by a sequencer circuit (e.g., flow control circuit 106 of FIGS. 1-2).

### BIT CELL AREA OPTIMIZATION

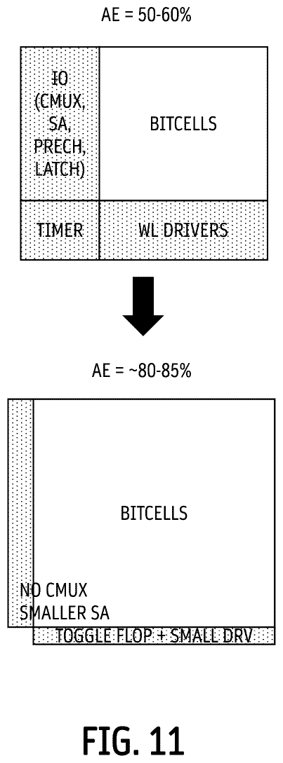

FIG. 11 illustrates bit cell area optimization, according to some embodiments of the disclosure. According to one aspect, the models-on-silicon chip illustrated in FIGS. 1-4 benefits from reduced bit cell area. Due to relaxed performance requirement and architecture enabled circuit optimization, the area of a bit cell in ROM can be reduced. The models-on-silicon chip has array efficiency (AE) between 80-85%, which may translate to 1.5× density gain.

### Custom Multiplier Circuits

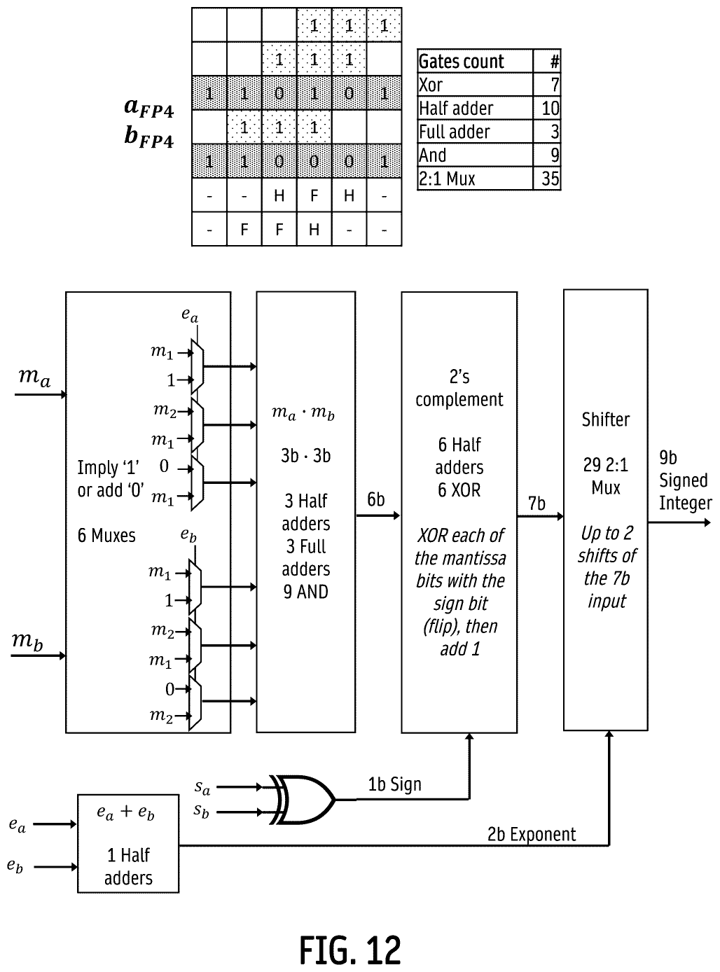

FIG. 12 illustrates a weights multiplier circuit, according to some embodiments of the disclosure. According to one aspect, a weights multiplier implements tailor made optimized hardware for specific floating-point multiplication. In contrast to the multiplication circuit 908 of FIG. 9, the logic shown in FIG. 12 implements multiplying a FP4 input by a FP8 input.

It is envisioned by the disclosure that various custom floating-point multiplication logic can be implemented for performing floating-point multiplication on the models-on-silicon chip (e.g., FP4×FP8, FP6×FP8, FP16×FP16, etc.).

### Softmax Circuit

FIG. 13 illustrates SoftMax circuit 1300, according to some embodiments of the disclosure. According to one aspect, the models-on-silicon chip includes a hardware implementation of the SoftMax function, e.g.:

$$\frac{{e}^{\frac{{x}_{i} - {x}_{max}}{\sqrt{128}}}}{{\sum }_{j = 0}^{t} {e}^{\frac{{x}_{j} - {x}_{max}}{\sqrt{128}}}}$$

SoftMax circuit 1300 depicted in FIG. 13 includes look up table implementation of a SoftMax function and is not a compute-oriented solution. SoftMax circuit 1300 receives an input vector of t FP16 elements (1<t<512) and return the SoftMax normalized vector of the same size. SoftMax circuit 1300 receives 16 numbers per cycle for up to 32 cycles and returns 16 numbers per cycle for up to 32 cycles. SoftMax circuit 1300 can have the following exemplary specification:

SoftMax
Description
Receives an input vector of t FP16 elements
(1 < t < 512) and returns the SoftMax normalized
vector of the same size. Receives 16 numbers per
cycle for up to 32 cycles and returns 16 numbers
per cycle for up to 32 cycles.
Inputs

| Input Vector | X16 FP16 | 256 | |
|---|---|---|---|
| SoftMax compare | Control | 1 | b |
| SoftMax normalize | Control | 1 | b |
| SoftMax exponent | Control | 1 | b |
| SoftMax multiply | Control | 1 | b |
| SoftMax on/off | Control | 1 | b |

Outputs

| | | | |
|---|---|---|---|
| SoftMax-ed Vector | x16 UFP16 | 240 | b |

Details
Unit receives x16 FP16 number every clock
cycle for 16 clock cycles.
Numbers are stored in a first-in-first-out (FIFO)
buffer, while they are compared to find the
largest number in the vector.
FIFO buffer outputs numbers, largest number
subtracted, exponent the result with a look
up table, and enter a further FIFO buffer.
Numbers are pulled out of the further FIFO
and multiplied by the normalization value.
Total output takes 24 cycles - 8 latency, 16 piping.

| | |
|---|---|
| Instances | 32 |

SoftMax circuit 1300 may be included in an ADU to perform SoftMax on an input vector (e.g., FP16 vector) and to output a SoftMax-ed vector (e.g., FP16 vector). SoftMax circuit 1300 may include ROM 1302 storing a look up table comprising one or more precomputed values of an exponent function:

$$f ( x ) = {e}^{\frac{x}{\sqrt{128}}} .$$

SoftMax circuit 1300 may include ROM 1304 storing a look up table comprising one or more precomputed values of a reciprocal function:

$$f ( x ) = \frac{1}{x} .$$

SoftMax circuit 1300 may include tree adder 1306 to add a number of values (e.g., 18 values) together simultaneously.

### Maximizing Floating-Point Range

According to one aspect, the models-on-silicon chip maximizes floating-point range. The chip may implement predefined floating-point tables and ranges that do not have Inf (infinity) nor NaN (not a number) numbers. The predefined tables and ranges can be used because the data into each module is controlled, which enables a non-overflow process, and enables maximizing the range of numbers.

### Embedder Circuit

FIG. 14 illustrates embedder circuit 1400, according to some embodiments of the disclosure. A models-on-silicon chip includes a hardware implementation to produce an embedding vector (e.g., 4096 FP16 elements) of the input token. Embedder circuit 1400 can return 256 elements every clock cycle for 16 clocks cycles. As depicted, embedder circuit 1400 may include a number of ROMs to store look up tables. The example shown includes 256 ROMs storing 256 look up tables. Embedder circuit 1400 can have the following exemplary specification:

Embedder
Description
Returns the embedding vector (4,096 FP16
elements) of the input token.
Returns 256 elements every clock for 16
clocks cycles.
Inputs

| | | | |
|---|---|---|---|
| Token | 15 b Integer | 15 | b |
| Embedder cycle | Control | 4 | b |
| Embedder run | Control | 1 | b |
| Embedder on/off | Control | 1 | b |

Outputs

| | | | |
|---|---|---|---|
| Embedding Vector | x256 FP16 | 4,096 | b |

Details
Total embedder size is 250 MB - 4,096 × 32,000 × 2 B.
Embedder is divided into 256 1,000 KB look up
tables, each with 512,000 lines and FP16
output, since each of the 32,000 tokens in
the vocabulary is broken into 16 chunks of
256 numbers.
For ROM implementation, once the first out of
16 numbers are read from the table,
reading from the ROM is sequential for 16
cycles, so only the next line needs to be
pre-charged.
After working for 16 cycles, the embedder unit
is asleep for about 10,000 cycles.
May use power gating.

| | |
|---|---|
| Instances | 1 |

### Rms Normalizer Circuit

FIG. 15 illustrates RMS normalizer circuit 1500, according to some embodiments of the disclosure. The models-on-silicon chip implements a hardware implementation of an RMS normalizer function:

$$\frac{{x}_{i} \cdot {W}_{{RMS}_{i}}}{\sqrt{\frac{{\sum }_{j = 0}^{4 , 096} {x}_{j}^{2}}{4 , 096} + {10}^{- 5}}}$$

RMS normalizer circuit 1500 can receive an input vector (e.g., 4096 FP16 elements) and return an RMS-normalized vector (e.g., 4096 elements in FP8 format). RMS normalizer circuit 1500 can receive 256 elements every clock for 16 clocks cycles. RMS normalizer circuit 1500 can have the following exemplary specification:

RMS Normalizer
Description
Receives an input vector of 4,096 FP16 elements
and return the RMS-normalized vector of 4,096
elements in FP8 format. Returns 256 elements
every clock for 16 clocks cycles.
Inputs

| | | | |
|---|---|---|---|
| Input Vector | x256 FP16 | 4,096 | b |
| RMS run input | Control | 1 | b |
| RMS normalize | Control | 1 | b |
| RMS run output | Control | 1 | b |
| RMS on/off | Control | 1 | b |

Outputs

| | | | |
|---|---|---|---|
| Normalized Vector | x256 FP8 | 2,048 | b |

Details
Unit receives x256 FP16 number every clock
cycle for 16 clock cycles.
Numbers are stored in FIFO buffer, and in
parallel they are squared and summed - 4
cycles latency.
After all numbers have been summed, a look
up table returns the normalization value - 1
cycle latency.
Numbers are pulled out of the FIFO bufferand
multiplied by the normalization value, then
multiplied by weight from ROM, then sampled FP8.
Total output takes 24 cycles - 8 latency, 16 piping.

| | |
|---|---|
| Instances | 1 |

RMS normalizer circuit 1500 may include tree adder 1502 to add a number of values (e.g., 256 values) together simultaneously. RMS normalizer circuit 1500 may include ROM 1504 storing a look up table comprising one or more precomputed values of the function:

$$f ( x ) = {\sqrt{\frac{x}{4 , 096} + 1 {0}^{- 5}}}^{- 1} .$$

### Sampler Circuit

FIG. 16 illustrates sampler circuit 1600, according to some embodiments of the disclosure. FIG. 17 illustrates sampling comparator circuit 1602 that can be implemented in sampler circuit 1600, according to some embodiments of the disclosure. According to one aspect, the models-on-silicon chip implements a hardware implementation of a sampler to return a token (e.g., an index, such as a 32-bit index) corresponding to the largest number in an input vector (e.g., 32,000 elements input vector having logits). Sampler circuit 1600 may implement a deterministic sampler having zero temperature. Sampler circuit 1600 may have the following exemplary specification:

Sampler
Description
Returns the token (32-bit index) of the largest
number in the 32,000 elements input vector.
This is a hardware implementation of a
deterministic Sampler (Zero temperature).
Inputs

| | | | |
|---|---|---|---|
| Logits vector | x256 FP16 | 4,096 | b |
| Sampler on/off | Control | 1 | b |
| Sampler restart | Control | 1 | b |
| Sampler run | Control | 1 | b |

Outputs

| | | | |
|---|---|---|---|
| Output token | 15 b Integer | 15 | b |

Details
For 125 clock cycles (time it takes to calculate
Wcls), 256 FP16 numbers are received from
the 256 matrix multiplication (e.g., vector
dot product) circuits.
For best performance, Sampler may to
compare the 256 incoming FP16 numbers
every clock cycle and keep the index and
value of the largest number.
If more then one number has the largest
value, Sampler returns the token with the
lowest index out of the equal tokens.
Latency is 9 clock cycles - Every layer of
comparators is pipelined.
May include power gating for this unit.

| | |
|---|---|
| Instances | 1 |

Sampling comparator circuit 1602 may have the following exemplary specification:

Sampling Comparator
Description
Compares two FP16 numbers (logits) and returns
the larger number and its index (token).
Inputs

| | | | |
|---|---|---|---|
| Value A | FP16 | 16 | b |
| Index A (Token) | 15 b Integer | 15 | b |
| Value B | FP16 | 16 | b |
| Index B (Token) | 15 b Integer | 15 | b |

Outputs

| | | | |
|---|---|---|---|
| Larger Value | FP16 | 16 | b |
| Larger value's index | 15 b Integer | 15 | b |

Details
Output in ready in a single clock cycle.
Flopped.

| | |
|---|---|
| Instances | 256 |

The models-on-silicon chip may include sampler circuit 1600 to return a token of the largest number in an input vector (e.g., the index in the input vector corresponding to the largest value the input vector).

In some embodiments, sampler circuit 1600 includes a tree comparator circuit having many layers of instances of sampling comparator circuit 1602 arranged in a tree structure or hierarchical structure to efficiently compare a large number of values (e.g., hundreds or thousands of values or more) simultaneously.

### Rotary Embedder Circuit

FIG. 18A illustrates a rotary positional encoding (RoPE) circuit 1800, according to some embodiments of the disclosure. FIG. 18B illustrates a cosine function and a sine function, according to some embodiments of the disclosure. The models-on-silicon chip implements a hardware implementation of a rotary positional encoder to produce rotary positional encoded embeddings. Circuit 1800 is implemented to provide the functionality of a sine cosine unit without the need to calculate/compute sine and cosine in real-time. The sine cosine unit has a look up table implementation. Rotary positional encoding circuit 1800 may include ROM 1802 to store a look up table comprising one or more precomputed values of a cosine function

$$( e . g . , f ( t ) = cos ( {10}^{- \frac{{h}_{n}}{16}} \cdot t ) ) .$$

Rotary positional encoding circuit 1800 may include ROM 1804 to store a look up table comprising one or more precomputed values of sine function

$$( e . g . , f ( t ) = sin ( {10}^{- \frac{{h}_{n}}{16}} \cdot t ) ) .$$

### Scaling the Models-On-Silicon Architecture

In some embodiments, an apparatus can include a processing circuit implementing an application (e.g., a user application), and can receive input data and generate one or more input tokens. The apparatus can further include an inferencing circuit, such as a models-on-silicon chip as described herein. The inferencing circuit can receive the one or more input tokens and output one or more output tokens. In some embodiments, the processing circuit receives one or more output tokens generated by the inferencing circuit.

The models-on-silicon architecture is modular and can be scaled to implement larger transformer-based neural networks.

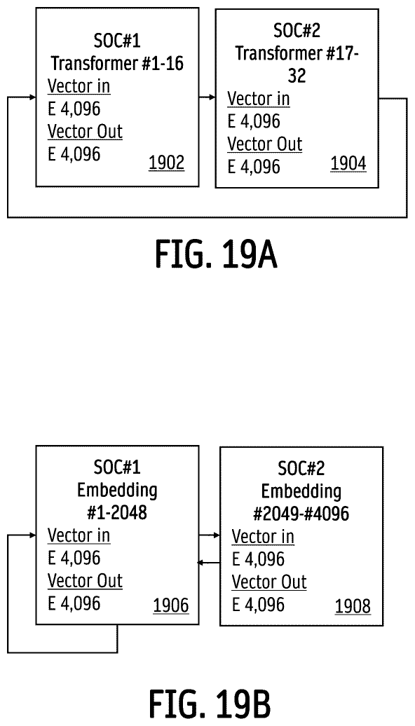

FIG. 19A illustrates using multiple chips to implement a large transformer model, according to some embodiments of the disclosure. FIG. 19B illustrates using multiple chips to implement a large transformer model, according to some embodiments of the disclosure. According to one aspect, models-on-silicon architecture enables scaling through multi-chip implementation. To implement huge models such as models with more than 1 trillion parameters, multiple instances of the models-on-silicon chips can be arranged together in the various manners illustrated in FIGS. 19A-B. For example, transformer output of 4096 vectors of one chip can be passed using a GPIO output to another chip, and so on. Many chips can be coupled together to form a larger transformer model architecture and scale as needed.

Referring to FIG. 19A, multiple models-on-silicon chips can be stacked, where chip 1902 may embed one subset of transformers, e.g., transformers 1-16, of a transformer-based neural network, and chip 1904 can embed a further subset of transformers, e.g., transforms 17-32, of the transformer-based neural network. Chip 1904 (e.g., a further inferencing circuit) can receive the one or more output tokens from chip 1902 (e.g., the inferencing circuit) and output one or more further output tokens. The one or more further output tokens can be fed back as input to chip 1902 in an auto-regressive manner.

Referring to FIG. 19B, multiple models-on-silicon chips can be parallelized (e.g., implementing tensor parallelism), where chip 1906 may perform processing of a subset of embedding values, e.g., embedding values 1-2048, of embedding vector having 4096 elements, and chip 1908 may perform processing of a further subset of embedding values, e.g., embedding values 2049-4096, of embedding vector having 4096 elements.

### Hardware-Based Inferencing Process

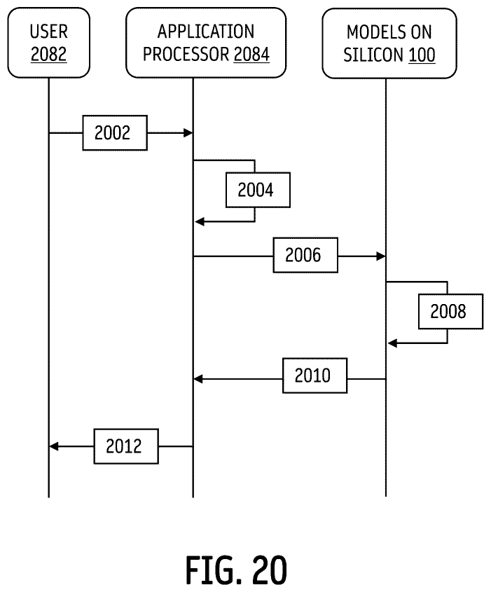

FIG. 20 illustrates hardware-based inferencing process with embedded LLM and ROM, according to some embodiments of the disclosure. According to one aspect, the process of using the models-on-silicon chip to implement a model such as a transformer model is different from the traditional inferencing process involving a GPU.

The process of using the models-on-silicon chip 100 begins in 2002 with user 2082 providing input data for inferencing. User 2082 may provide input data to application processor 2084 (sometimes referred to as a host processor) implementing a user application.

In 2004, application processor 2084 may tokenize the input data and transform the input data into tokenized embeddings.

In 2006, the tokenized embeddings are passed onto models-on-silicon chip 100. In some embodiments, the input data as one or more tokens can be loaded into models-on-silicon chip 100 as a vector of tokens, or a vector of token embeddings.

Unlike traditional setups using GPUs, the model and its weights are already embedded in the ROM of models-on-silicon chip 100. The step of loading models or weights from external sources is eliminated.

In 2008, the models-on-silicon chip 100 performs inference and executes a transformer-based neural network. The tokenized embeddings are processed by models-on-silicon, using the weights of the model, which are read directly from the embedded ROM (e.g., SRO memory). This means that the information used for the inferencing process is available on models-on-silicon chip 100 itself, leading to faster data retrieval and processing. The information is retrieved from the ROM, it is moved to one or more circuits for processing and execution. The one or more circuits are coupled to form a feedforward network within models-on-silicon chip 100. The feedforward network handles the inferencing computations and operations and is orchestrated by a sequencer circuit to perform operations according to a timing sequence to generate one or more output tokens. The models-on-silicon chip 100 computes the output token. If a next output token is to be generated, the output token can be fed back to models-on-silicon chip 100 as an input to generate a next output token in an auto-regressive manner.

In 2010, after processing, one or more output tokens are directed back to the application processor 2084.

Notably, the input and output interfaces of models-on-silicon (interfacing with application processor 2084) are very low bandwidth interfaces. Since the (entire) inference model architecture and weights are embedded in the SoC, the only data being input and output are tokens. Usually, each token is the size of 2 Bytes (based on the vocabulary size).

In 2012, the application processor 2084 may process the one or more output tokens and generate user output representing the inferencing result back to user 2082.

This approach of embedding the model and its weights in the hardware models-on-silicon chip 100 significantly streamlines the inferencing process, reducing latency and increasing efficiency, as it eliminates the need for external memory and data transfer. By hardcoding or etching the weights and model onto models-on-silicon chip 100 itself, it eliminates the need to load these weights from random-access memory for each task, thereby reducing power consumption and improving processing speed. The design of models-on-silicon chip 100 enables it to handle the complex calculations for machine learning inferencing tasks in real-time applications.

### Enhanced Matrix Multiplication Operations

In some embodiments, the models-on-silicon chip 100 implements Embedded Weights and models Fused Multiply-Add Architecture (EWFMAA) to perform matrix multiplication operations. This architecture can be designed specifically to perform Fused Multiply-Add (FMA) operations with embedded weights and models, significantly enhancing the efficiency of matrix operations in machine learning tasks.

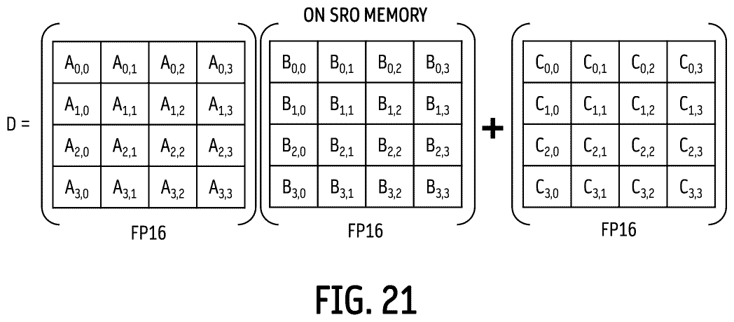

The solution may implement a series of cores, each providing a matrix processing array which performs the operation D=A*B+C, where A, B, C and D are FP16 matrices. The operation is illustrated in FIG. 21. A feature of this architecture is that the weight matrix B is hardcoded directly onto the chip, eliminating the need to load these weights from external random-access memory for each inference task.

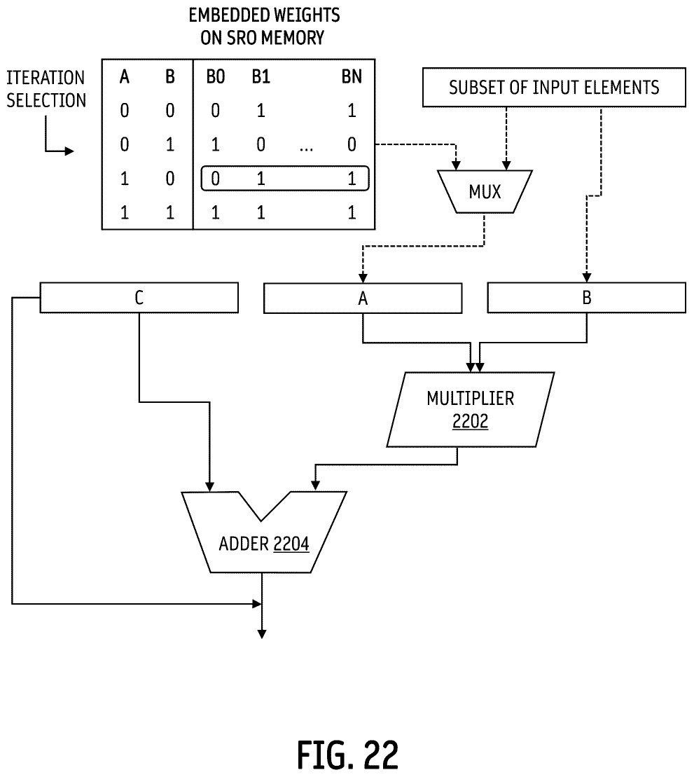

Exemplary logic for implementing EWFMAA is illustrated in FIG. 22. The flow of operations within the EWFMAA is as follows: (1) the hardcoded weights are retrieved, (2) the input data matrix A & B for the inference task are loaded, (3) each core having multiplier 2202 and adder 2204 performs the FMA operation D=A*B+C, where D is FP16 matrix, and C is an accumulator, (4) process continues until the dot operation is complete.

The architecture with its embedded weights, model and optimized transformer operations such as FMA operations, normalization, activation and SoftMax provides a highly efficient and powerful solution for inference tasks. It significantly reduces power consumption and enhances processing speed, making it ideal for applications demanding real-time inference and low-power consumption.

### AI Cube: Stacked Architecture

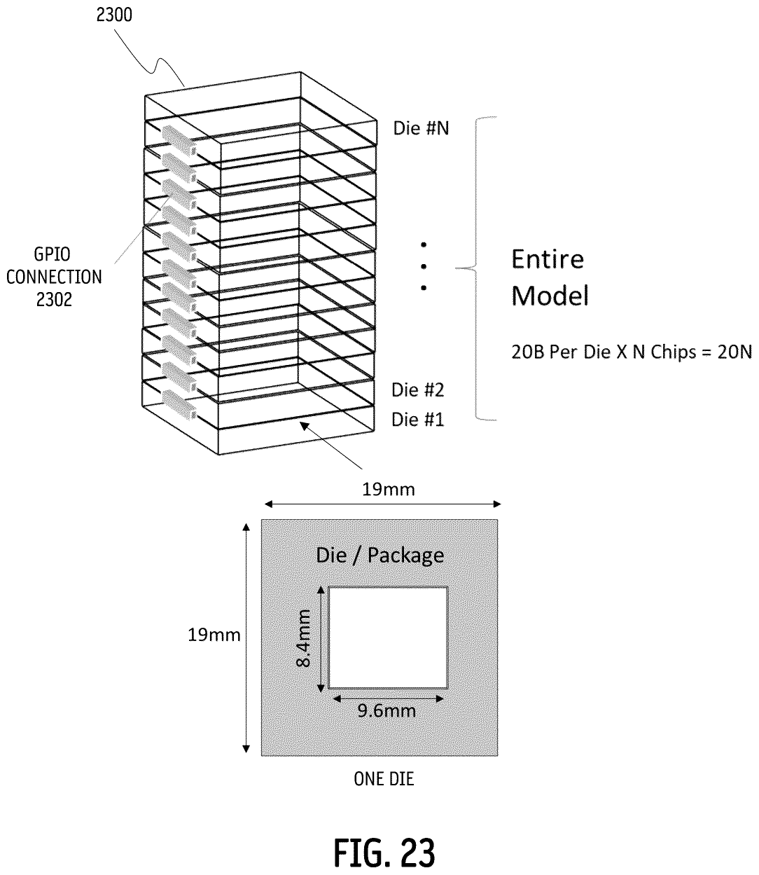

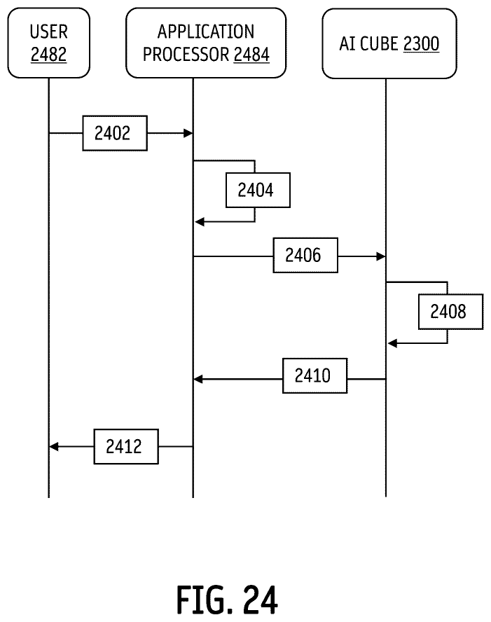

FIG. 23 illustrates an exemplary stacked architecture and design of AI cube 2300, according to some embodiments of the disclosure. The stacked architecture and design of AI cube 2300, referred to as the AI cube architecture, leverages models-on-silicon solution (as illustrated by FIGS. 1-22) to encapsulate the LLM weights and inference architecture directly onto silicon or hardware. LLMs can be scaled by stacking more chips. By embedding the model directly onto the silicon chip using the models-on-silicon solution, performance of the LLM can be improved by eliminating the need for constant loading of weights and models into GPUs for every computation. The AI cube architecture involves a hierarchy where individual chips or dies are stacked on top of each other, and each chip/die has a specific set of one or more transformers or transformer blocks. As seen in FIG. 24, AI cube 2300 has N number of chips or dies implementing the models-on-silicon solution, seen as (seen as Die #1, Die #2, . . . . Die #N). By organizing the transformers or transformer blocks of a transformer-based neural network (e.g., as illustrated in FIG. 3) appropriately into the stack of chips/dies, it is possible for AI cube 2300 to process data, e.g., execute LLM tasks, in a feedforward manner where only one chip/die is active at a given time.

In one example, AI cube 2300 can have a plurality of chips (or dies). AI cube 2300, an integrated circuit device, can include a chip having a SRO memory (or a ROM) to store one or more weight values of a weight matrix of a transformer-based neural network. The chip can further include one or more circuits to perform one or more operations of an inferencing task of the transformer-based neural network, e.g., utilizing the one or more weight values in the SRO memory. The chip can include an output pin (or pad). AI cube 2300 can include a further chip at a stacking side of the chip. In other words, the further chip is stacked vertically on top of the chip. The further chip can include a further SRO memory (or a further ROM) to store one or more further weight values of a further weight matrix of the transformer-based neural network. The further chip can further include one or more further circuits to perform one or more further operations of the inferencing task of the transformer-based neural network, e.g., utilizing the one or more further weight values in the further SRO memory. The further chip can include an input pin (or pad). AI cube 2300 includes a conductive path that couples the output pin of the chip to the input pin of the further chip.

An exemplary conductive path connecting two chips in AI cube 2300 is shown as GPIO connection 2302. The conductive path can be a conductive wire. The output pin of the chip can be a GPIO pin. The input pin of the further chip can be GPIO pin.

To make it practical for the chips or dies to be stacked in this compact configuration, the one or more circuits of the chip can include a matrix multiplier to perform one or more vector dot product operations that multiply a vector having a predetermined size and predetermined bit representation and a further vector having a further predetermined size and a further predetermined bit representation. Bit representation refers to how data is encoded in binary form, and examples of bit representation include: FP4, FP6, FP8, FP12, FP16, INT8, etc.) Similarly, the one or more further circuits of the further chip can include a further matrix multiplier to perform one or more vector dot product operations that multiply a vector having a predetermined size and predetermined bit representation and a further vector having a further predetermined size and a further predetermined bit representation. The fixed matrix multiplier implementation on the individual chips in AI cube 2300 is possible because the model weights and the model architecture are predefined and set. In other words, the matrix multiplication operation, along with the input size and bit representations, is predefined and fixed. Fixed and/or custom circuitry can be implemented to carry the exact matrix multiplication operation in hardware. The reduction in hardware complexity allows for the chips/dies to run cooler and have less risk of thermal issues when stacked in such a compact form.

### Using the AI Cube in an Inferencing Process

FIG. 24 illustrates hardware-based inferencing process with an AI cube (e.g., AI cube 2300), according to some embodiments of the disclosure. According to one aspect, the process of using AI cube 2300 to implement a model such as a transformer-based neural network model is different from the traditional inferencing process involving a GPU. The process involves user 2482, application processor 2484 implementing an application for user 2482, and AI cube 2300. AI cube 2300 can include an input and output interface to communicate application processor 2484.

The process of using AI cube 2300 begins in 2402 with user 2482 providing input data for inferencing. User 2482 may provide input data to application processor 2484 (sometimes referred to as a host processor) implementing a user application.

In 2404, application processor 2484 may tokenize the input data and transform the input data into tokenized embeddings.

In 2406, the tokenized embeddings are passed onto AI cube 2300. For example, application processor 2484 can input one or more input tokens of the transformer-based neural network to an input interface of AI cube 2300. AI cube 2300 may receive one or more input tokens for the inferencing task. In some embodiments, the input data as one or more tokens can be loaded into AI cube 2300 as a vector of tokens, or a vector of token embeddings, e.g., via the input interface of AI cube 2300.

Unlike traditional setups using GPUs, the model and its weights are already embedded in the ROM of AI cube 2300. The step of loading models or weights from external sources is eliminated.

In 2408, AI cube 2300 performs inference and executes a transformer-based neural network. The tokenized embeddings are processed by AI cube 2300 along with the weights of the model, which are read directly from the embedded ROM (e.g., SRO memory) of AI cube 2300. This means that the information used for the inferencing process is available on AI cube 2300 itself, leading to faster data retrieval and processing. The information is retrieved from the ROM, it is moved to one or more circuits for processing and execution. The one or more circuits within a chip, and the chips in the plurality of chips of AI cube 2300 are coupled to form a feedforward network within AI cube 2300. The feedforward network handles the inferencing computations and operations and is orchestrated by individual sequencer circuits in the plurality of chips of AI cube 2300 to perform operations according to a timing sequence to generate one or more output tokens. AI cube 2300 computes the output token. If a next output token is to be generated, the output token can be fed back to AI cube 2300 as an input to generate a next output token in an auto-regressive manner. A chip in AI cube 2300 can process the one or more input tokens using one or more weight values of a weight matrix of the transformer-based neural network etched on a ROM or SRO memory of the chip.

In 2410, after processing, one or more output tokens are directed back to the application processor 2484. AI cube 2300 can output, e.g., via an output interface of AI cube 2300, an output token for the inferencing task produced by the transformer-based neural network to application processor 2484.

Notably, the input and output interfaces of models-on-silicon (interfacing with application processor 2084) are very low bandwidth interfaces. Since the (entire) inference model architecture and weights are embedded in the SoC, the only data being input and output are tokens. Usually, each token is the size of 2 Bytes (based on the vocabulary size).

In 2412, the application processor 2084 may process the one or more output tokens and generate user output representing the inferencing result back to user 2482.

This approach of embedding the transformer-based neural network and its weights in the hardware of AI cube 2300 significantly streamlines the inferencing process, reducing latency and increasing efficiency, as it eliminates the need for external memory and data transfer. By hardcoding or etching the weights and model onto the chips of AI cube 2300, it eliminates the need to load these weights from random-access memory for each task, thereby reducing power consumption and improving processing speed. The design and architecture of AI cube 2300 enables it to handle the complex calculations for machine learning inferencing tasks in real-time applications.

### Cooling Via Airgap Between Chips in the AI Cube

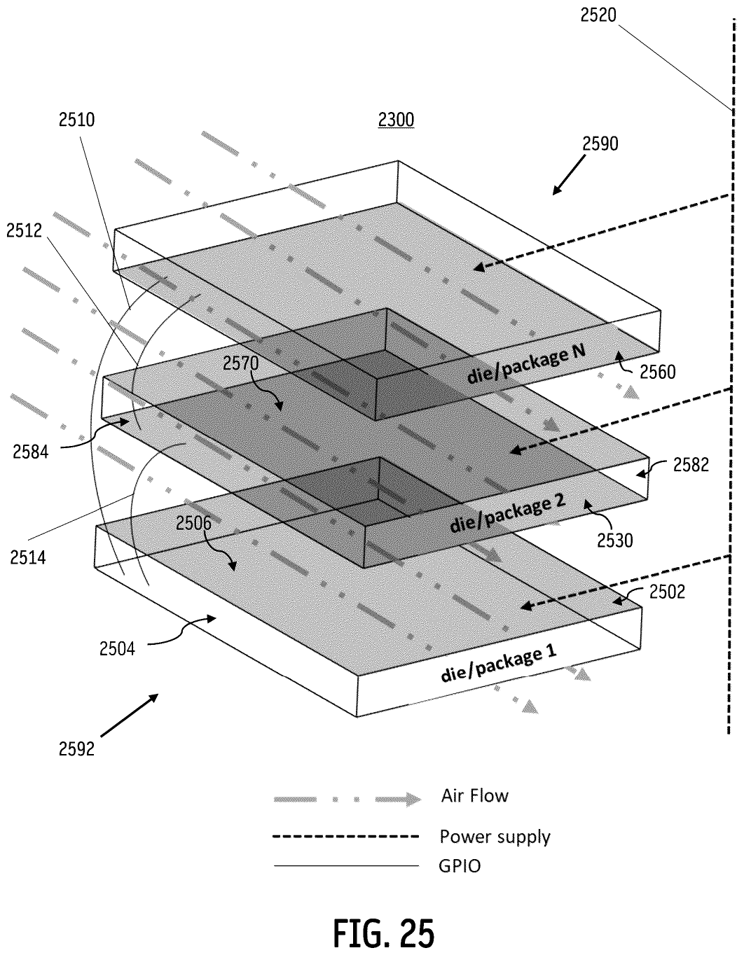

The AI cube solution can integrate a cooling mechanism into its design. By stacking the chips/dies and connecting them with GPIO from one side (e.g., as illustrated in FIG. 24) and power from the other (e.g., opposite side of the GPIO, as illustrated in FIG. 25), the device allows for a unique air flow configuration.

FIG. 25 illustrates airflow configuration of the stacked architecture and design, according to some embodiments of the disclosure. AI cube 2300 has N chips, e.g., die/package 1, die/package 2, . . . die/package N, implementing models-on-silicon solution. Die/package 1 has non-stacking side 2504 and non-stacking side 2502. Die/package 2 has non-stacking side 2584 and non-stacking side 2582. Other dies/packages have respective non-stacking sides. Non-stacking side 2504 and non-stacking side 2502 are opposite of each other or are on opposite sides of die/package 1. Non-stacking side 2584 and non-stacking side 2582 are opposite of each other or are on opposite sides of die/package 2. Die/package 1 has stacking side 2506 facing stacking side 2530 of die/package 2. Die/package 2 has stacking side 2570 facing stacking side 2560 of die/package N, if N=3.

Power supply 2520 may be on a non-stacking side of AI cube 2300, such as non-stacking side 2590. GPIO connections (seen as conductive path 2510, conductive path 2512, and conductive path 2514) may be on an opposite, non-stacking side of AI cube 2300, such as non-stacking side 2592.

In some embodiments, one or more conductive paths offering inter-chip or inter-die communication for the chips in AI cube 2300 can be located on a non-stacking side of the chips, e.g., non-stacking side 2592. For die/package 1, one or more conductive paths are at non-stacking side 2504. For die/package 1, one or more conductive paths are at non-stacking side 2584.

In the example shown, conductive path 2514 connects or couples die/package 1 to die/package 2. Die/package 1 can send output data to die/package 2 via conductive path 2514. Conductive path 2512 connects or couples die/package 2 to die/package N, if N=3. Die/package 2 can send output data to die/package N, if N=3, via conductive path 2512. Conductive path 2510 connects or couples die/package N, if N=3 back to die/package 1. Die/package N, if N=3 can send data back to die/package 1, via conductive path 2510.

In some embodiments, one or more power supply paths (or wires) supplying power to the chips in AI cube 2300 can be located on a further non-stacking side of the chips, e.g., non-stacking side 2590. For die/package 2, the power supply path can be located at non-stacking side 2582. Die/package 2 can include a bond pad at non-stacking side 2582. The bond pad is connectable to a power rail (or power supply 2520) to supply power to the die/package 2 via a power layer of die/package 2 at stacking side 2530 facing stacking side 2506.

In some cases, power supply may be on one non-stacking side of AI cube 2300, and GPIO connections may be on another non-stacking side of AI cube 2300 that is next to the non-stacking side.

The power can run beneath each chip, e.g., via a power layer of the chip. The power layer can face a stacking side of an adjacent chip in AI cube 2300. For die/package 2, the power layer of die/package 2 can be located at stacking side 2530 facing stacking side 2506 of die/package 1. For die/package N, if N=3, the power layer of die/package N can be located at stacking side 2560 facing stacking side 2570 of die/package 2. The power layer beneath each chip can create a channel for air flow in a direction different from the other cooling systems. In particular, between two adjacent chips in the stacked configuration of AI cube 2300 is an airgap or airgap layer. An exemplary direction of air flow is depicted in FIG. 25. The air flow configuration illustrated in FIG. 25 not only aids in cooling but can contribute to the overall efficiency and longevity of the device. By preventing heat accumulation, airgaps or airgap layers reduces thermal stress on the components, thus extending their operational lifespan. In addition, the effective cooling system helps to maintain high computational speeds by avoiding thermal throttling, which is a common issue in high-performance computing devices.

### Liquid Cooling Via Microfluidic Channels in AI Cube

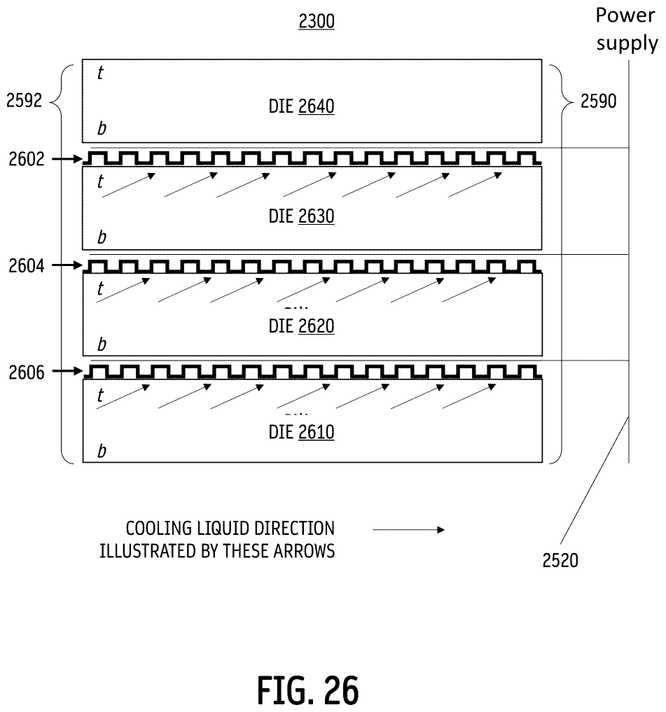

FIG. 26 illustrates microchannels of the stacked architecture and design, according to some embodiments of the disclosure. In some implementations, AI cube 2300 stack can include microchannels, or microfluidic channels running between each stacked silicon chip/die of AI cube 2300. In the illustration AI cube 2300 includes N=4 dies, shown as die 2610, die 2620, die 2630, and die 2640, in a stacked configuration. The dies can implement the models-on-silicon solution, such as including SRO memory and fixed matrix multipliers.

Microfluidic channels 2606 can be formed between a stacking side of die 2610 and a stacking side of die 2620 that are facing each other. Microfluidic channels 2606 can be located next to the power layer of die 2620, which can be disposed at the bottom side of die 2620 (marked by the letter b). Microfluidic channels 2604 can be formed between a stacking side of die 2620 and a stacking side of die 2630 that are facing each other. Microfluidic channels 2604 can be located next to the power layer of die 2630, which can be disposed at the bottom side of die 2630 (marked by the letter b). Microfluidic channels 2602 can be formed between a stacking side of die 2630 and a stacking side of die 2640 that are facing each other. Microfluidic channels 2602 can be located next to the power layer of die 2640, which can be disposed at the bottom side of die 2630 (marked by the letter b).

As illustrated, microfluidic channels 2602 can be formed by etching or forming channels on the top side of die 2630 (marked by the letter t). However, it is envisioned that microfluidic channels 2602 can be formed by etching or forming channels on the bottom side of die 2640, or by etching or forming channels on the top side of die 2630 and the bottom side of die 2640. Microfluidic channels 2604 can be formed by etching or forming channels on the top side of die 2620 (marked by the letter t). However, it is envisioned that microfluidic channels 2604 can be formed by etching or forming channels on the bottom side of die 2630, or by etching or forming channels on the top side of die 2620 and the bottom side of die 2630. Microfluidic channels 2606 can be formed by etching or forming channels on the top side of die 2610 (marked by the letter t). However, it is envisioned that microfluidic channels 2604 can be formed by etching or forming channels on the bottom side of die 2620, or by etching or forming channels on the top side of die 2610 and the bottom side of die 2620.

These microchannels can be filled with a cooling liquid, which can be chosen for its superior thermal conductivity and non-electrically conductive properties. As these channels run over the stacking surfaces of each silicon chip in AI cube 2300, the cooling liquid absorbs the heat generated by the chips, effectively reducing their temperature. Examples of cooling liquids (or coolants) that can be used to fill the microfluidic channels include purified water, deionized water, ethylene glycol, propylene glycol, fluorocarbon liquids, fluorochemical liquids, silicone oil, poly-alpha-olefin, silicate ester, etc.

AI cube 2300 may further include a system that circulates the cooling liquid through the microfluidic channels using a pump. The system may include a heat exchanger, a chiller, or other suitable device for cooling the cooling liquid before the liquid is returned into the microfluidic channels. The cooling liquid may include additives to prevent corrosion of the different components or to allow operation at higher/lower temperatures (e.g., additives to water to decrease its freezing point or increase its boiling point). The cooling liquid used may depend on the coolant's properties, including viscosity and heat capacity, circulation flow rate, and the temperature rise during device operation.

In some embodiments, the cooling liquid may be an electronic coolant liquid or a dielectric fluid that is electrically insulating, highly thermally stable, non-toxic, chemically inert, non-corrosive with high thermal conductivity. A dielectric fluid may include a dielectric material in a liquid state. For example, the fluid may be an ultra-low-viscosity dielectric heat transfer fluid that includes synthetic hydrocarbon oils. In some embodiments, the fluid may not include sulfur. In some embodiments, the fluid may include a transformer oil, perfluoroalkanes, and purified water.

The microfluidic channels can have different patterns, cross-sectional shapes and/or cross-sectional sizes. Examples of cross-section shapes can include, round, oval, rectangular, or diamond. The microfluidic channels can extend along the stacking surface of a model-on-silicon die. The microfluidic channels can have a hollow structure. The paths over the stacking sides of the chips can vary. In some cases, microfluidic channels may have paths near specific circuits in the logic layer of the die expected to dissipate more heat than other circuits to perform (additional) cooling for those specific circuits. The direction of cooling liquid flow can be into the page or out of the page.

The incorporation of microchannels can be a part of the silicon production process itself. These microchannels can be etched or formed directly into the silicon wafers during the fabrication process. The silicon wafers can go through a series of process steps such as lithography, etching, and deposition to create these microchannels. This approach ensures that the channels are an intrinsic part of the chip layout and are precisely placed for optimal cooling efficiency. In some manufacturing processes, the cooling liquid can be introduced into these channels after the silicon chips have been stacked together. This seamless integration of the cooling system into the silicon production process can ensure optimal heat removal and may contribute to the overall efficiency and performance of the device. This liquid cooling solution can be more efficient than air cooling, as liquids have a higher capacity to absorb and dissipate heat. The introduction of liquid cooling via microchannels ensures that even in a compact, high-density setup, each individual chip is effectively cooled, thereby significantly reducing the risk of overheating. This cooling solution can allow for optimal performance and efficiency, even under high computational loads, making the AI cube solution a breakthrough in AI inference technology.

In some embodiments, the microfluidic channels can be etched from the substrate material and filled with a sacrificial material, such as silicon dioxide (SiO₂), polysilicon, or polyimide. After AI cube has been formed from vertically stacked models-on-silicon dies, a fluid (e.g., a coolant, or a solvent) may be pumped through the microfluidic channels to remove the sacrificial material. Coolant may then replace the sacrificial material, or the material used to remove the sacrificial material, so that coolant flows through the microfluidic channels.

### Ai Cube as a System and Process Executed by the Ai Cube

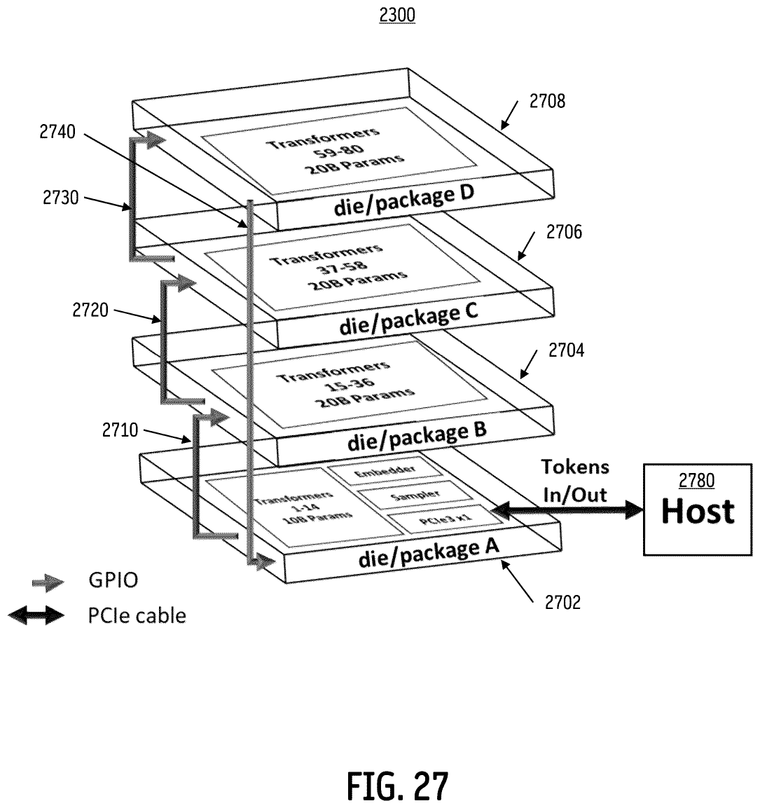

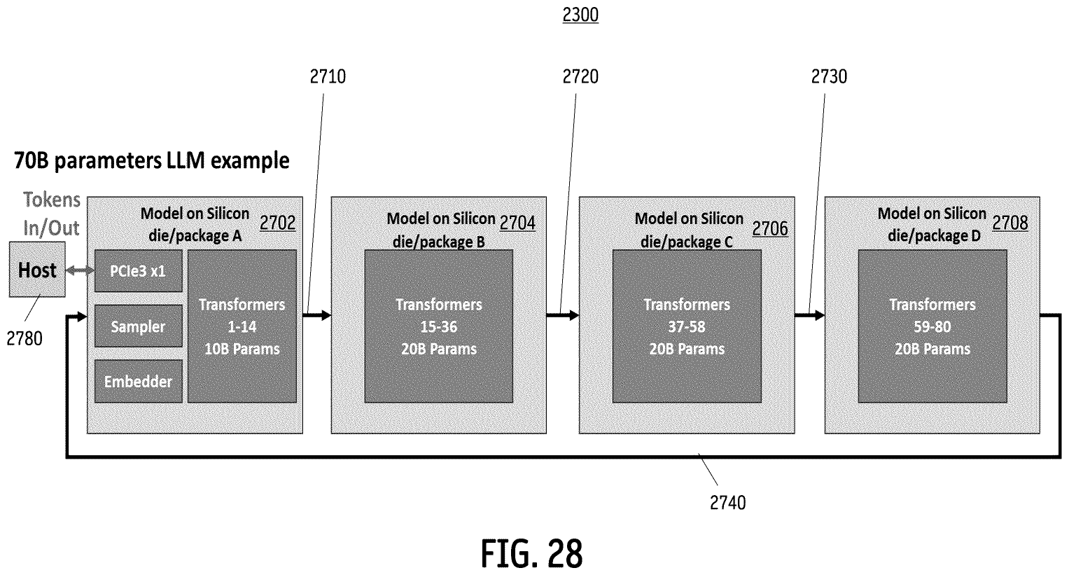

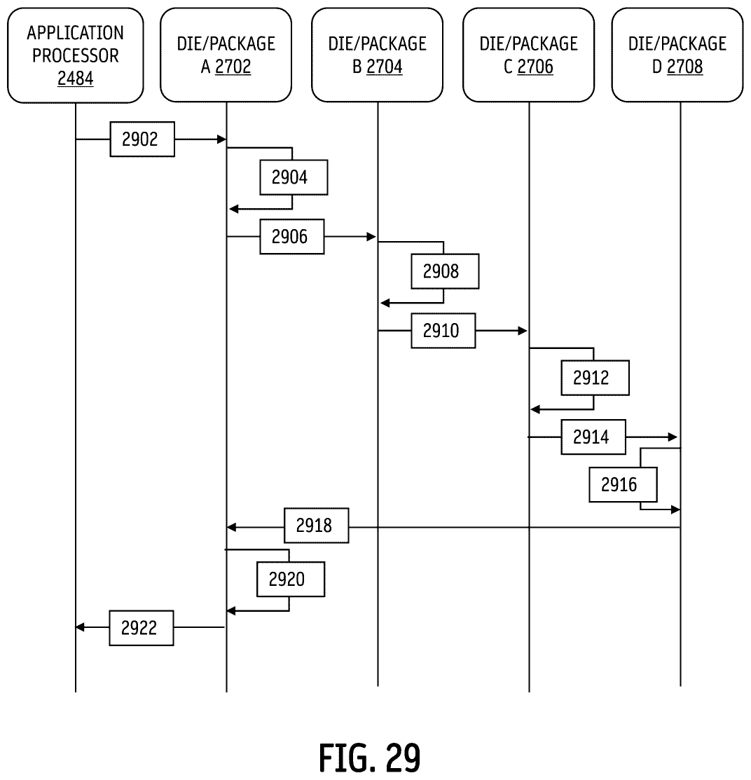

FIGS. 27-28 illustrate an exemplary implementation of an LLM onto the stacked architecture and design, according to some embodiments of the disclosure. FIG. 29 illustrates an exemplary data flow in an execution of the LLM implementation as illustrated in FIGS. 27-28, according to some embodiments of the disclosure.

The AI cube solution can scale to any LLM size by adding more chips. The AI cube can support a transformer-based model such as a transformer-based LLM. An example of a 70 billion parameter LLM can be arranged and implemented onto AI cube 2300 as illustrated in FIGS. 27-28. A transformer-based model can be broken down into sets of transformer blocks which can be implemented onto several stacked chips/dies. The 70 billion parameter LLM may have 80 transformer blocks, e.g., transformers 1-80. Different groups of transformer blocks are distributed to different chips in AI cube 2300 in a feedforward manner.

AI cube 2300 includes a plurality of chips in a stacked configuration. As illustrated in FIGS. 27-28, AI cube can include N=4 chips, die/package A 2702, die/package B 2704, die/package C 2706, and die/package D 2708. The chips can implement models-on-silicon solution. A chip of the plurality of chips, e.g., any one of die/package A 2702, die/package B 2704, die/package C 2706, and die/package D 2708, includes a ROM or SRO memory storing one or more weight values of a weight matrix of a transformer-based neural network and one or more circuits, one or more circuits to perform one or more operations of an inferencing task of the transformer-based neural network using the one or more weight values stored on ROM.

Die/package A 2702 can embed or etch transformer blocks 1-14. Die/package A 2702 can include one or more ROM or SRO memories to store weights corresponding to transformer blocks 1-14, and one or more circuits to perform operations in transformer blocks 1-14.

Die/package B 2704 can embed or etch transformer blocks 15-26. Die/package B 2704 can include one or more ROM or SRO memories to store weights corresponding to transformer blocks 15-26, and one or more circuits to perform operations in transformer blocks 15-26.

Die/package C 2706 can embed or etch transformer blocks 37-58. Die/package C 2706 can include one or more ROM or SRO memories to store weights corresponding to transformer blocks 37-58, and one or more circuits to perform operations in transformer blocks 37-58.

Die/package D 2708 can embed or etch transformer blocks 59-80. Die/package D 2708 can include one or more ROM or SRO memories to store weights corresponding to transformer blocks 37-58, and one or more circuits to perform operations in transformer blocks 59-80.

GPIO connection 2710 may connect an output pin of die/package A 2702 to an input pin of die/package B 2704. Die/package A 2702 can transmit a signal (e.g., output an output tensor produced by transformer 14) from the output pin of die/package A 2702 to the input pin of die/package B 2704 via GPIO connection 2710.

GPIO connection 2720 may connect an output pin of die/package B 2704 to an input pin of die/package C 2706. Die/package B 2704 can transmit a signal (e.g., output an output tensor produced by transformer 36) from the output pin of die/package B 2704 to the input pin of die/package C 2706 via GPIO connection 2720.

GPIO connection 2730 may connect an output pin of die/package C 2706 to an input pin of die/package D 2708. Die/package C 2706 can transmit a signal (e.g., output an output tensor produced by transformer 58) from the output pin of die/package C 2706 to the input pin of die/package D 2708 via GPIO connection 2730.

In some embodiments, GPIO connection 2740 may connect an output pin of die/package D 2708 (looping back) to an input pin of die/package A 2702. Die/package A 2702 can receive a signal (e.g., an output tensor produced by transformer 80) from the output pin of die/package D 2708 at the input pin of die/package A 2702 via GPIO connection 2740.

For one of the chips in AI cube 2300, e.g., die/package A 2702, the chip can include an input interface, shown as “PCIe3×1” in FIGS. 27-28. The input interface allows host processor 2780 to communicate with AI cube 2300. Host processor 2780 can input one or more input tokens (“tokens in”) of the transformer-based neural network to the input interface of the chip.

In some cases, the same chip, e.g., die/package A 2702, or a different chip in AI cube 2300, can include an output interface, shown as “PCIe3×1” in FIGS. 27-28. The output interface allows AI cube 2300 to communicate with host processor 2780. AI cube 2300 can output an output token of the transformer-based neural network to host processor 2780 via the output interface.

For one of the chips in AI cube 2300, e.g., die/package A 2702, the chip can include a sampler circuit, shown as “Sampler” in FIGS. 27-28. The sampler circuit, as described and illustrated herein, can return a token corresponding to a largest value in an input vector. The input vector can be the output vector of the last transformer block (e.g., transformer 80). The sampler circuit may include tree comparator circuit, which can be efficient for comparing values in the input vector.

In some cases, die/package A 2702 can include the sampler circuit, and receives the input vector from die/package D via GPIO connection 2740. The output of the sampler circuit can be transmitted to host processor 2780, via an output interface of die/package A 2702.

In some cases, die/package D 2708 (or the last chip in AI cube 2300) can include the sampler circuit. In some cases, the output token produced by the sampler circuit in die/package D 2708 can be sent to die/package A 2702 via GPIO connection 2740, and die/package A 2702 may include an output interface to output the output token to host processor 2780. In some cases, die/package D 2708 (or the last chip in AI cube 2300) can includes an output interface to output the output token produced by the sampler circuit to host processor 2780.

For one of the chips in AI cube 2300, e.g., die/package A 2702, the chip can include an embedder circuit, shown as “Embedder” in FIGS. 27-28. The embedder circuit, as described and illustrated herein, can output an embedding vector based on the one or more input tokens to the transformer-based neural network received via the input interface of the chip (e.g., “PCIe3 jx1”). The embedder circuit can include one or more look up tables, which can be efficient for producing the embedding vector.

A data path may be implemented onto the AI cube design. The data path may include inputting one or more tokens (“tokens in”) from host processor 2780, e.g., via a PCIe3 input/output interface, to AI cube 2300. The data path may include data moving from one chip/die to a next chip/die in stacked AI cube 2300. The data path may include one or more tokens (“tokens out”) from AI cube 2300, e.g., via a PCIe3 input/output interface, to host processor 2780. The hardware design breaks up the transformer-based neural network at the boundaries of transformer blocks and maintains the feedforward processing pattern. As a result, the data path is deterministic and can be low bandwidth.

Referring to FIG. 29, in 2902, application processor 2484 may send one or more input tokens to a die/package A 2702 of AI cube 2300 in FIGS. 27-28, e.g., via an input interface of die/package A 2702.

In 2904, die/package A 2702 can use the embedder to produce an embedding vector. Die/package A 2702 can execute operations corresponding to one group of transformer blocks (e.g., “Transformers 1-14” having around 10 billion parameters).

Once the computation reaches the 14th transformer, in 2906, the output tensor of the 14^{th} transformer is moved to die/package B 2704 stacked above the die/package A 2702, e.g., via GPIO connection 2710.

In 2908, die/package B 2704 execute operations corresponding to a further group of transformer blocks (e.g., “Transformers 15-36” having around 20 billion parameters).

Once the computation reaches the 36th transformer, in 2910, the output tensor of the 36th transformer is moved to die/package C 2706 stacked above die/package B 2704, e.g., via GPIO connection 2720.

In 2912, die/package C 2706 execute operations corresponding to a further group of transformer blocks (e.g., “Transformers 37-58” having around 20 billion parameters).

Once the computation reaches the 58^{th} transformer, in 2914, the output tensor of the 58^{th} transformer is moved to die/package D 2708 stacked above die/package C 2706, e.g., via GPIO connection 2730.

In 2916, die/package D 2708 execute operations corresponding to a further group of transformer blocks (e.g., “Transformers 59-80” having around 20 billion parameters).

Once the computation reaches the 80th transformer, in 2918, the output tensor of the 80th transformer is moved to (or looped back to) die/package A 2702, e.g., via GPIO connection 2740.

In 2920, die/package A 2702 can use the sampler to produce an output token.

In 2922, application processor 2484 may receive the output token from die/package A 2702 of AI cube 2300, e.g., via an output interface of die/package A 2702.

This design and data flow illustrated in FIGS. 27-29 demonstrate the potential for scaling to any model size simply by adding more stacked chips. As illustrated in the data flow of FIG. 29, only one chip/die is active at a given point in time during the LLM execution. Because die/package A 2702 may include one or more of: an input/output interface, a sampler circuit, and an embedder circuit, fewer transformer blocks with less weights are embedded in die/package A 2702 than other dies/packages in AI cube 2300.

### Addressing a Potential Limitation: Multiple AI Cubes in a Bundle

Once the model weights are etched onto the silicon, the weights cannot be changed. Fine-tuning options may be available to allow for around 2% change of the weights. But the model after etching is fixed and will not be replaced for the AI cube. To address this potential limitation, it is possible to have multiple AI cubes in a bundle, each taking care of a different version of a model.

### Comparison of the AI Cube Solution Against Other Solutions: Area

GPU-based or similar solutions have cooling and peripherals which make the entire product that enables the model to be loaded to be large (usually a full rack in a data center). Dimensions can be around W: 50 cm, H: 190 cm, D: 80 cm, which equates to 538,089.34 cm³ in rack volume. While such solutions allow for changing of the model weights, these solutions are not optimized and can take 20,000 times more space. These solutions are placed in a data center due to size.

In comparison, the AI cube stacks one die on top of the other, and would enable the entire model to be in a cube-sized product. One die at around 30 mm square and stacked up 1.5 mm with 10 dies like a cube can take up around 27 cm³ for the entire model. The AI cube can be around 20,000 times smaller. The AI cube can be installed in small form factors and devices.

### Comparison of the AI Cube Solution Against Other Solutions: Power Distribution

With GPU-based solutions, the model weights are loaded onto GPU and memory which needs to be powered on the entire process. This is roughly 6 KW for the entire time it is working. While such solutions allow for changing of the model weights, these solutions are not optimized for power and latency optimized. Every data retrieval requires all the memory to be loaded in memory with high power requirements. These solutions are placed in a data center due to size.

In comparison, using the AI cube solution, power is only allocated to the current working or active die out of the entire product. This turning on a chip/die can be done using a shared clock and synchronizing/triggering a chip to start working when receiving data. Power gating can be implemented. This advantage comes from the fact that only one chip/die having a particular set of transformer(s) is active at any given time. This feature means that power consumption and thermal heating of the entire product can be reduced, and the product can be in small form factors since cooling peripherals are not needed.

### Exemplary Use Cases

Data Centers: The chip can be used in data centers for tasks that require inference. With a reduction in power consumption and increase in speed.

Edge Computing and Mobile: The chip can be used in edge computing devices, which require low-power consumption and fast processing times. This could include anything from IoT devices to mobile phones.

Autonomous Vehicles: The chip can be used in autonomous vehicles to quickly and efficiently make real-time decisions. The speed is particularly advantageous in this scenario.

Medical Devices: The chip can be used in medical devices that require real-time inference, such as diagnostic devices or monitoring equipment. The low-power consumption and fast processing times are crucial in these applications.

Security applications: The chip can be used in security applications where speed, reliability and security are crucial. These could include surveillance systems, autonomous drones, or equipment for data analysis and threat detection, as the model and weights are hardcoded into the hardware, model integrity is assured and less susceptible to manipulation.

### Method for Performing Inference Using an AI Cube

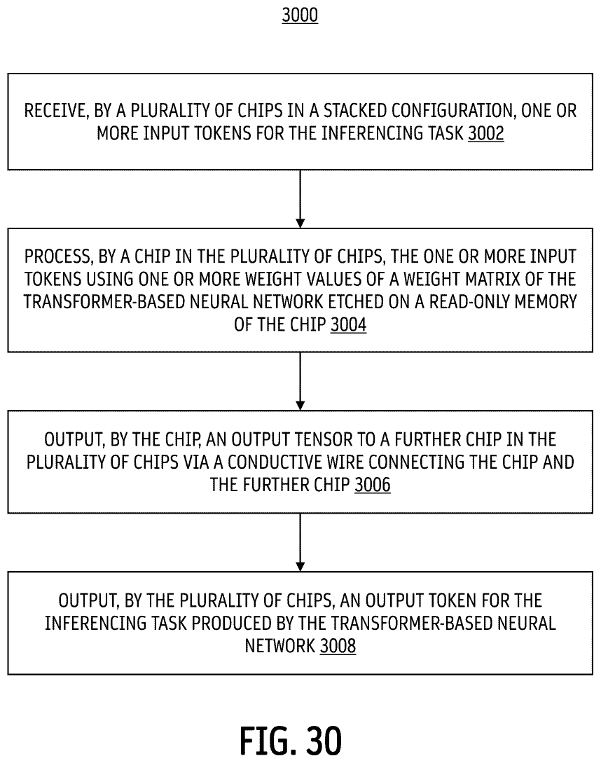

FIG. 30 is a flow diagram illustrating method 3000 for performing inference on an AI cube, according to some embodiments of the disclosure. Method 3000 may be carried out AI cube as described and illustrated herein.

In 3002, a plurality of chips in a stacked configuration, the AI cube, can receive one or more input tokens for the inferencing task.

In 3004, a chip in the plurality of chips can process the one or more input tokens, using one or more weight values of a weight matrix of the transformer-based neural network etched on a read-only memory of the chip. The chip can embed a transformer block.

In 3006, the chip can output an output tensor to a further chip in the plurality of chips via a conductive wire connecting the chip and the further chip. The further chip can embed a further transformer block.

In 3008, the plurality of chips can output an output token for the inferencing task produced by the transformer-based neural network, e.g., to an application processor.

In some embodiments, method 3000 further includes the further chip processing the output tensor, using one or more further weight values of a further weight matrix of the transformer-based neural network etched on a further read-only memory of the chip.

In some embodiments, the chip or another chip has a sampler circuit, and the sampler circuit may return a token corresponding to a largest value in an input vector as the output token.

In some embodiments, the chip has an embedder circuit, and processing the one or more input tokens includes the embedder circuit generating an embedding vector based on the one or more input tokens.

In some embodiments, the chip and/or the further chip can perform matrix multiplication through performing one or more vector dot product operations that multiply a vector having a predetermined size and predetermined bit representation having the one or more weight values of the weight matrix and a further vector having a further predetermined size and a further predetermined bit representation.

In some embodiments, the one or more input tokens are received from an application processor via an input interface of the chip in plurality of chips.

In some embodiments, the output token is transmitted to an application processor via an output interface of the chip in plurality of chips (or a different chip in the plurality of chips).

### Exemplary Computing Device

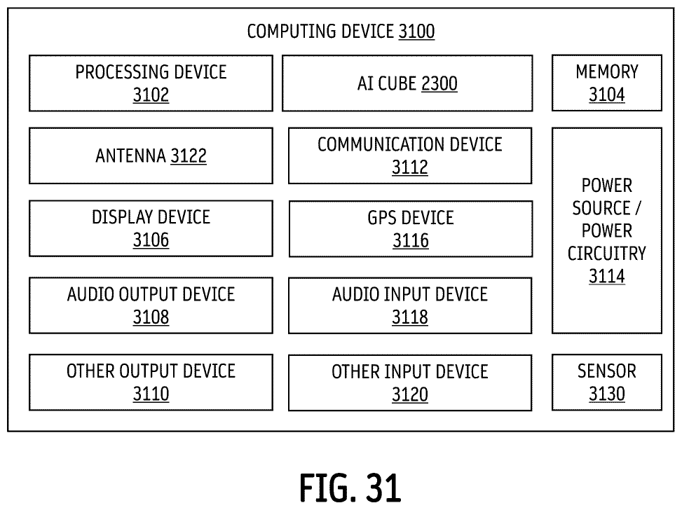

FIG. 31 is a block diagram of an apparatus or a system, e.g., an exemplary computing device 3100, according to some embodiments of the disclosure. One or more computing devices 3100 may be used to implement the functionalities described with the FIGS. and herein. A number of components are illustrated in the FIGS. can be included in the computing device 3100, but any one or more of these components may be omitted or duplicated, as suitable for the application. In some embodiments, some or all of the components included in the computing device 3100 may be attached to one or more motherboards. In some embodiments, some or all of these components are fabricated onto a single SoC die. Additionally, in various embodiments, the computing device 3100 may not include one or more of the components illustrated in FIG. 31, and the computing device 3100 may include interface circuitry for coupling to the one or more components. For example, the computing device 3100 may not include a display device 3106, and may include display device interface circuitry (e.g., a connector and driver circuitry) to which a display device 3106 may be coupled. In another set of examples, the computing device 3100 may not include an audio input device 3118 or an audio output device 3108 and may include audio input or output device interface circuitry (e.g., connectors and supporting circuitry) to which an audio input device 3118 or audio output device 3108 may be coupled.

The computing device 3100 may include a processing device 3102 (e.g., one or more processing devices, one or more of the same types of processing device, one or more of different types of processing device). The processing device 3102 may include electronic circuitry that process electronic data from data storage elements (e.g., registers, memory, resistors, capacitors, quantum bit cells) to transform that electronic data into other electronic data that may be stored in registers and/or memory. Examples of processing device 3102 may include a CPU, a GPU, a quantum processor, a machine learning processor, an artificial intelligence processor, a neural network processor, an artificial intelligence accelerator, an application specific integrated circuit (ASIC), an analog signal processor, an analog computer, a microprocessor, a digital signal processor, a FPGA, a TPU, a data processing unit (DPU), etc.

In some embodiments, the computing device 3100 may include AI cube 2300 as described herein. AI cube 2300 can interface with processing device 3102 to accelerate inference.

The computing device 3100 may include a memory 3104, which may itself include one or more memory devices such as volatile memory (e.g., DRAM), nonvolatile memory (e.g., ROM), HBM, flash memory, solid state memory, and/or a hard drive. Memory 3104 includes one or more non-transitory computer-readable storage media. In some embodiments, memory 3104 may include memory that shares a die with the processing device 3102.

In some embodiments, memory 3104 includes one or more non-transitory computer-readable media storing instructions executable to perform operations described with the FIGS. and herein. Memory 3104 may store instructions that generate inputs to AI cube 2300. Memory 3104 may store instructions that process outputs from AI cube 2300. The instructions stored in the one or more non-transitory computer-readable media may be executed by processing device 3102.

In some embodiments, memory 3104 may store data, e.g., data structures, binary data, bits, metadata, files, blobs, etc., as described with the FIGS. and herein. Data may include inputs to AI cube 2300. Data may include outputs from AI cube 2300.

In some embodiments, the computing device 3100 may include a communication device 3112 (e.g., one or more communication devices). For example, the communication device 3112 may be configured for managing wired and/or wireless communications for the transfer of data to and from the computing device 3100. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 3112 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 3112 may operate in accordance with a Global System for Mobile Communication (GSM), General Packet Radio Service (GPRS), Universal Mobile Telecommunications System (UMTS), High-Speed Packet Access (HSPA), Evolved HSPA (E-HSPA), or LTE network. The communication device 3112 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 3112 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 3112 may operate in accordance with other wireless protocols in other embodiments. The computing device 3100 may include an antenna 3122 to facilitate wireless communications and/or to receive other wireless communications (such as radio frequency transmissions). The computing device 3100 may include receiver circuits and/or transmitter circuits. In some embodiments, the communication device 3112 may manage wired communications, such as electrical, optical, or any other suitable communication protocols (e.g., the Ethernet). As noted above, the communication device 3112 may include multiple communication chips. For instance, a first communication device 3112 may be dedicated to shorter-range wireless communications such as Wi-Fi or Bluetooth, and a second communication device 3112 may be dedicated to longer-range wireless communications such as global positioning system (GPS), EDGE, GPRS, CDMA, WiMAX, LTE, EV-DO, or others. In some embodiments, a first communication device 3112 may be dedicated to wireless communications, and a second communication device 3112 may be dedicated to wired communications.

The computing device 3100 may include power source/power circuitry 3114. The power source/power circuitry 3114 may include one or more energy storage devices (e.g., batteries or capacitors) and/or circuitry for coupling components of the computing device 3100 to an energy source separate from the computing device 3100 (e.g., DC power, AC power, etc.).

The computing device 3100 may include a display device 3106 (or corresponding interface circuitry, as discussed above). The display device 3106 may include any visual indicators, such as a heads-up display, a computer monitor, a projector, a touchscreen display, a liquid crystal display (LCD), a light-emitting diode display, or a flat panel display, for example.

The computing device 3100 may include an audio output device 3108 (or corresponding interface circuitry, as discussed above). The audio output device 3108 may include any device that generates an audible indicator, such as speakers, headsets, or earbuds, for example.

The computing device 3100 may include an audio input device 3118 (or corresponding interface circuitry, as discussed above). The audio input device 3118 may include any device that generates a signal representative of a sound, such as microphones, microphone arrays, or digital instruments (e.g., instruments having a musical instrument digital interface (MIDI) output).

The computing device 3100 may include a GPS device 3116 (or corresponding interface circuitry, as discussed above). The GPS device 3116 may be in communication with a satellite-based system and may receive a location of the computing device 3100, as known in the art.

The computing device 3100 may include a sensor 3130 (or one or more sensors). The computing device 3100 may include corresponding interface circuitry, as discussed above). Sensor 3130 may sense physical phenomenon and translate the physical phenomenon into electrical signals that can be processed by, e.g., processing device 3102. Examples of sensor 3130 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 3100 may include another output device 3110 (or corresponding interface circuitry, as discussed above). Examples of the other output device 3110 may include an audio codec, a video codec, a printer, a wired or wireless transmitter for providing information to other devices, haptic output device, gas output device, vibrational output device, lighting output device, home automation controller, or an additional storage device.

The computing device 3100 may include another input device 3120 (or corresponding interface circuitry, as discussed above). Examples of the other input device 3120 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 3100 may have any desired form factor, such as a handheld or mobile computer system (e.g., a cell phone, a smart phone, a mobile Internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an IoT device, or a wearable computer system. In some embodiments, the computing device 3100 may be any other electronic device that processes data.

### Select Examples

Example 1 provides an integrated circuit device, including a chip having a sequential read-only memory to store one or more weight values of a weight matrix of a transformer-based neural network, one or more circuits to perform one or more operations of an inferencing task of the transformer-based neural network, and an output pin; a further chip at a stacking side of the chip, the further chip having a further sequential read-only memory to store one or more further weight values of a further weight matrix of the transformer-based neural network, one or more further circuits to perform one or more further operations of the inferencing task of the transformer-based neural network, and an input pin; and a conductive path coupling the output pin of the chip to the input pin of the further chip.

Example 2 provides the integrated circuit device of example 1, where: the conductive path is a conductive wire; the output pin is a general-purpose input/output pin; and the input pin is a further general-purpose input/output pin.

Example 3 provides the integrated circuit device of example 1 or 2, where: the conductive path is located on a non-stacking side of the chip.

Example 4 provides the integrated circuit device of any one of examples 1-3, where: the further chip further includes a bond pad at a non-stacking side of the chip, the bond pad connectable to a power rail to supply power to the further chip via a power layer of the further chip facing the stacking side of the chip.

Example 5 provides the integrated circuit device of any one of examples 1-4, further including an airgap layer between the chip and the further chip at the stacking side of the chip.

Example 6 provides the integrated circuit device of any one of examples 1-5, further including one or more microfluidic channels between the chip and the further chip at the stacking side of the chip.

Example 7 provides the integrated circuit device of any one of examples 1-6, where: the chip further includes an input interface to receive one or more input tokens to the transformer-based neural network.

Example 8 provides the integrated circuit device of any one of examples 1-7, where: the chip further includes an output interface to output an output token generated by the transformer-based neural network.

Example 9 provides the integrated circuit device of any one of examples 1-8, where: the chip further includes a further input pin to receive an output tensor generated by the transformer-based neural network.

Example 10 provides the integrated circuit device of any one of examples 1-9, where: the one or more circuits of the chip includes a sampler circuit to return a token corresponding to a largest value in an input vector, the sampler circuit including a tree comparator circuit.

Example 11 provides the integrated circuit device of any one of examples 1-10, where: the one or more circuits of the chip includes an embedder circuit to output an embedding vector based on one or more input tokens to the transformer-based neural network received via an input interface of the chip.

Example 12 provides the integrated circuit device of any one of examples 1-11, where: the one or more circuits of the chip include a matrix multiplier to perform one or more vector dot product operations that multiply a vector having a predetermined size and predetermined bit representation and a further vector having a further predetermined size and a further predetermined bit representation.

Example 13 provides an apparatus, including a plurality of chips in a stacked configuration, where a chip of the plurality of chips includes a read-only memory storing one or more weight values of a weight matrix of a transformer-based neural network and one or more circuits, one or more circuits to perform one or more operations of an inferencing task of the transformer-based neural network, an input interface, and an output pin to transmit a signal to a further chip of the plurality of chips; and an application processor to input one or more input tokens of the transformer-based neural network to the input interface of the chip.

Example 14 provides the apparatus of example 13, where: the chip of the plurality of chips further includes an input pin to receive a signal from a yet further chip of the plurality of chips.

Example 15 provides the apparatus of example 13 or 14, where: the application processor to receive an output token generated by the transformer-based neural network from an output interface of the chip.

Example 16 provides the apparatus of any one of examples 13-15, where: the one or more circuits of the chip of the plurality of chips includes a sampler circuit to return a token corresponding to a largest value in an input vector, the sampler circuit including a tree comparator circuit.

Example 17 provides the apparatus of any one of examples 13-16, where: the one or more circuits of the chip of the plurality of chips includes an embedder circuit to output an embedding vector based on the one or more input tokens to the transformer-based neural network received via the input interface of the chip.

Example 18 provides the apparatus of any one of examples 13-17, where: the one or more circuits of the chip include a matrix multiplier to perform one or more vector dot product operations that multiply a vector having a predetermined size and predetermined bit representation and a further vector having a further predetermined size and a further predetermined bit representation.

Example 19 provides a method for performing an inferencing task of a transformer-based neural network, including receiving, by a plurality of chips in a stacked configuration, one or more input tokens for the inferencing task; processing, by a chip in the plurality of chips, the one or more input tokens, using one or more weight values of a weight matrix of the transformer-based neural network etched on a read-only memory of the chip; outputting, by the chip, an output tensor to a further chip in the plurality of chips via a conductive wire connecting the chip and the further chip; and outputting, by the plurality of chips, an output token for the inferencing task produced by the transformer-based neural network.

Example 20 provides the method of example 19, further including processing, by the further chip, the output tensor, using one or more further weight values of a further weight matrix of the transformer-based neural network etched on a further read-only memory of the chip.

Example 21 provides the method of example 19 or 20, further including returning, by a sampler circuit of the chip, a token corresponding to a largest value in an input vector as the output token.

Example 22 provides the method of any one of examples 19-21, where processing, by the chip, the one or more input tokens includes generating an embedding vector based on the one or more input tokens.

Example 23 provides the method of any one of examples 19-22, where processing, by the chip, the one or more input tokens includes perform one or more vector dot product operations that multiply a vector having a predetermined size and predetermined bit representation having the one or more weight values of the weight matrix and a further vector having a further predetermined size and a further predetermined bit representation.

Example 24 provides the method of any one of examples 19-23, where the one or more input tokens are received from an application processor via an input interface of the chip in plurality of chips.

Example 25 provides the method of any one of examples 19-24, where the output token is transmitted to an application processor via an output interface of the chip in plurality of chips.

Example 26 provides an apparatus including means to perform a method according to any one of examples 19-25.

### Variations and Other Notes

Although the operations of the example method shown in and described with reference to some of the FIGS. are illustrated as occurring once each and in a particular order, it will be recognized that the operations may be performed in any suitable order and repeated as desired. Additionally, one or more operations may be performed in parallel. Furthermore, the operations illustrated in some of the FIGS. may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. An integrated circuit device, comprising:
a chip having a sequential read-only memory to store one or more weight values of a weight matrix of a transformer-based neural network, one or more circuits to perform one or more operations of an inferencing task of the transformer-based neural network, and an output pin;
a further chip at a stacking side of the chip, the further chip having a further sequential read-only memory to store one or more further weight values of a further weight matrix of the transformer-based neural network, one or more further circuits to perform one or more further operations of the inferencing task of the transformer-based neural network, and an input pin; and
a conductive path coupling the output pin of the chip to the input pin of the further chip.

2. The integrated circuit device of claim 1, wherein:
the conductive path is a conductive wire;
the output pin is a general-purpose input/output pin; and
the input pin is a further general-purpose input/output pin.

3. The integrated circuit device of claim 1, wherein:
the conductive path is located on a non-stacking side of the chip.

4. The integrated circuit device of claim 1, wherein:
the further chip further includes a bond pad at a non-stacking side of the chip, the bond pad connectable to a power rail to supply power to the further chip via a power layer of the further chip facing the stacking side of the chip.

5. The integrated circuit device of claim 1, further comprising:
an airgap layer between the chip and the further chip at the stacking side of the chip.

6. The integrated circuit device of claim 1, further comprising:
one or more microfluidic channels between the chip and the further chip at the stacking side of the chip.

7. The integrated circuit device of claim 1, wherein:
the chip further includes an input interface to receive one or more input tokens to the transformer-based neural network.

8. The integrated circuit device of claim 1, wherein:
the chip further includes an output interface to output an output token generated by the transformer-based neural network.

9. The integrated circuit device of claim 1, wherein:
the chip further includes a further input pin to receive an output tensor generated by the transformer-based neural network.

10. The integrated circuit device of claim 1, wherein:
the one or more circuits of the chip includes a sampler circuit to return a token corresponding to a largest value in an input vector, the sampler circuit including a tree comparator circuit.

11. The integrated circuit device of claim 1, wherein:
the one or more circuits of the chip includes an embedder circuit to output an embedding vector based on one or more input tokens to the transformer-based neural network received via an input interface of the chip.

12. The integrated circuit device of claim 1, wherein:
the one or more circuits of the chip include a matrix multiplier to perform one or more vector dot product operations that multiply a vector having a predetermined size and predetermined bit representation and a further vector having a further predetermined size and a further predetermined bit representation.

13. An apparatus, comprising:
a plurality of chips in a stacked configuration, wherein a chip of the plurality of chips includes a read-only memory storing one or more weight values of a weight matrix of a transformer-based neural network and one or more circuits, one or more circuits to perform one or more operations of an inferencing task of the transformer-based neural network, an input interface, and an output pin to transmit a signal to a further chip of the plurality of chips; and
an application processor to input one or more input tokens of the transformer-based neural network to the input interface of the chip.

14. The apparatus of claim 13, wherein:
the chip of the plurality of chips further includes an input pin to receive a signal from a yet further chip of the plurality of chips.

15. The apparatus of claim 13, wherein:
the application processor to receive an output token generated by the transformer-based neural network from an output interface of the chip.

16. The apparatus of claim 13, wherein:
the one or more circuits of the chip of the plurality of chips includes a sampler circuit to return a token corresponding to a largest value in an input vector, the sampler circuit including a tree comparator circuit.

17. The apparatus of claim 13, wherein:
the one or more circuits of the chip of the plurality of chips includes an embedder circuit to output an embedding vector based on the one or more input tokens to the transformer-based neural network received via the input interface of the chip.

18. The apparatus of claim 13, wherein:
the one or more circuits of the chip include a matrix multiplier to perform one or more vector dot product operations that multiply a vector having a predetermined size and predetermined bit representation and a further vector having a further predetermined size and a further predetermined bit representation.

19. A method for performing an inferencing task of a transformer-based neural network, comprising:
receiving, by a plurality of chips in a stacked configuration, one or more input tokens for the inferencing task;
processing, by a chip in the plurality of chips, the one or more input tokens, using one or more weight values of a weight matrix of the transformer-based neural network etched on a read-only memory of the chip;
outputting, by the chip, an output tensor to a further chip in the plurality of chips via a conductive wire connecting the chip and the further chip; and
outputting, by the plurality of chips, an output token for the inferencing task produced by the transformer-based neural network.

20. The method of claim 19, further comprising:
processing, by the further chip, the output tensor, using one or more further weight values of a further weight matrix of the transformer-based neural network etched on a further read-only memory of the chip.
